(19) United States
(12) Patent Application Publication
(10) Pub. No.: US 2026/0163851 A1
(43) Pub. Date: Jun. 11, 2026

(54) COMMUNITY MESSAGE INTERACTION METHOD AND APPARATUS, ELECTRONIC DEVICE, AND STORAGE MEDIUM

(71) Applicant: TENCENT TECHNOLOGY (SHENZHEN) COMPANY LIMITED, Shenzhen (CN)

(72) Inventors: Ailu DENG, Shenzhen (CN); Hongfei ZENG, Shenzhen (CN); Rui SONG, Shenzhen (CN); Lin SHI, Shenzhen (CN); Shurun SHEN, Shenzhen (CN); Qinghua ZHONG, Shenzhen (CN)

(21) Appl. No.: 19/179,703

(22) Filed: Apr. 15, 2025

Related U.S. Application Data
(63) Continuation of application No. PCT/CN2024/087189, filed on Apr. 11, 2024.

(30) Foreign Application Priority Data
Apr. 12, 2023 (CN) 202310403068.3

(51) Int. Cl. H04L 51/046; H04L 51/063; H04L 51/212; H04L 51/52

(52) U.S. Cl. CPC H04L 51/046; H04L 51/063; H04L 51/212; H04L 51/52

(57) ABSTRACT

A community message interaction method includes presenting a message interaction interface in an initial form. The message interaction interface displays a plurality of message nodes associated with a target object, and the plurality of message nodes include one or more community nodes and one or more instant messaging (IM) nodes. The method further includes switching, in response to a selection operation for a target community node of the one or more community nodes, the message interaction interface from the initial form to a target form in which at least one screened community node associated with the target object is determined by screening. The target form displays a node identification of the at least one screened community node and at least one sub-community contained in the target community node, and the at least one screened community node includes the target community node.

### CROSS-REFERENCE TO RELATED APPLICATIONS

This application is a continuation of International Application No. PCT/CN 2024/087189, filed on Apr. 11, 2024, which claims priority to Chinese Patent Application No. 202310403068.3, entitled “COMMUNITY MESSAGE DISPLAY METHOD AND APPARATUS, ELECTRONIC DEVICE, AND STORAGE MEDIUM” and filed on Apr. 12, 2023, the entire contents of both of which are incorporated herein by reference.

### FIELD OF THE TECHNOLOGY

This application relates to Internet technologies and, in particular, to a community message interaction method and apparatus, an electronic device, and a storage medium.

### BACKGROUND OF THE DISCLOSURE

With the development of computer technologies, information transmission through the Internet becomes increasingly popular. For example, consumer to consumer (C2C) session communication and group chat are performed through an instant messaging (IM) application, and online interaction may be performed around specific interests or targets by joining online communities.

For a large online community having a plurality of diversified chat windows, interface hierarchies of social content and chat windows are relatively deep, and there are significant differences in interaction manners between the community social interaction and IM social interaction. How to combine the community with an IM capability to enable objects to naturally and smoothly navigate and experience in social scenes of different hierarchies and scales, such as C2C, group chat, and community, becomes a great challenge.

### SUMMARY

In accordance with the disclosure, there is provided a community message interaction method including presenting a message interaction interface in an initial form. The message interaction interface displays a plurality of message nodes associated with a target object, and the plurality of message nodes include one or more community nodes and one or more instant messaging (IM) nodes. The method further includes switching, in response to a selection operation for a target community node of the one or more community nodes, the message interaction interface from the initial form to a target form in which at least one screened community node associated with the target object is determined by screening. The target form displays a node identification of the at least one screened community node and at least one sub-community contained in the target community node, and the at least one screened community node includes the target community node.

Also in accordance with the disclosure, there is provided an electronic device including a processor and a memory storing a computer program that, when executed by the processor, causes the processor to present a message interaction interface in an initial form. The message interaction interface displays a plurality of message nodes associated with a target object, and the plurality of message nodes include one or more community nodes and one or more instant messaging (IM) nodes. The computer program, when executed by the processor, further causes the processor to switch, in response to a selection operation for a target community node of the one or more community nodes, the message interaction interface from the initial form to a target form in which at least one screened community node associated with the target object is determined by screening. The target form displays a node identification of the at least one screened community node and at least one sub-community contained in the target community node, and the at least one screened community node includes the target community node.

### BRIEF DESCRIPTION OF THE DRAWINGS

The accompanying drawings described herein are used for providing a further understanding of this application, and form a part of this application. Exemplary embodiments of this application and descriptions thereof are used for explaining this application, and do not constitute any inappropriate limitation to this application.

FIG. 1 is a schematic diagram showing an application scene according to an embodiment of this application.

FIG. 2 is an implementation flowchart of a community message interaction method according to an embodiment of this application.

FIG. 3 is a schematic diagram showing a message interaction interface in an initial form according to an embodiment of this application.

FIG. 4 is a schematic diagram showing the composition of elements of a community node according to an embodiment of this application.

FIG. 5 is a schematic diagram showing ongoing state identifications of some activities according to an embodiment of this application.

FIG. 6A is a schematic diagram showing a page transition according to an embodiment of this application.

FIG. 6B is a schematic diagram showing another page transition according to an embodiment of this application.

FIG. 7 is a schematic diagram showing a chat interface of a sub-community according to an embodiment of this application.

FIG. 8 is a schematic diagram showing a sub-community title information in a text link style according to an embodiment of this application.

FIG. 9 is a schematic diagram showing an interface return process according to an embodiment of this application.

FIG. 10 is a schematic diagram showing a message interaction interface according to an embodiment of this application.

FIG. 11 is a schematic diagram showing a community switching process according to an embodiment of this application.

FIG. 12 is a schematic diagram showing a sub-community viewing process after community switching according to an embodiment of this application.

FIG. 13 is a schematic diagram showing a community discovery interface according to an embodiment of this application.

FIG. 14 is a schematic diagram showing a community addition process according to an embodiment of this application.

FIG. 15 is a schematic diagram showing a Bezier curve according to an embodiment of this application.

FIG. 16 is a schematic diagram showing a temporary node identification according to an embodiment of this application.

FIG. 17 is a schematic diagram showing a presentation manner of chat information of a target IM node according to an embodiment of this application.

FIG. 18 is a schematic diagram showing a process for evoking a virtual keyboard according to an embodiment of this application.

FIG. 19 is a schematic diagram showing a process for returning to a message interaction interface according to an embodiment of this application.

FIG. 20 is a schematic diagram showing another presentation manner of chat information of a target IM node according to an embodiment of this application.

FIG. 21 is a schematic diagram showing another process for evoking a virtual keyboard according to an embodiment of this application.

FIG. 22 is a schematic diagram showing another process for returning to a message interaction interface according to an embodiment of this application.

FIG. 23 is a schematic diagram showing a message transmitting procedure according to an embodiment of this application.

FIG. 24 is a schematic diagram showing a message list loading procedure according to an embodiment of this application.

FIG. 25 is a schematic diagram showing a message list hierarchical structure according to an embodiment of this application.

FIG. 26 is a schematic diagram showing message interaction interfaces in an initial form and a target form according to an embodiment of this application.

FIG. 27A is a schematic diagram showing a first animation distribution procedure according to an embodiment of this application.

FIG. 27B is a schematic diagram showing a second animation distribution procedure according to an embodiment of this application.

FIG. 27C is a schematic diagram showing a third animation distribution procedure according to an embodiment of this application.

FIG. 27D is a schematic diagram showing a fourth animation distribution procedure according to an embodiment of this application.

FIG. 28 is a schematic structural diagram showing a community message interaction apparatus according to an embodiment of this application.

FIG. 29 is a schematic structural diagram showing hardware of an electronic device according to an embodiment of this application.

FIG. 30 is a schematic structural diagram showing hardware of another electronic device according to an embodiment of this application.

### DESCRIPTION OF EMBODIMENTS

To make the objectives, technical solutions, and advantages of the embodiments of the present disclosure clearer, the technical solutions of this application will be clearly and completely described below in conjunction with the accompanying drawings in the embodiments of this application. Apparently, the described embodiments are merely some embodiments of the technical solutions of this application rather than all of the embodiments. All other embodiments obtained by a person skilled in the art based on the embodiments recorded in this application without involving inventive effort shall fall within the protection scope of the technical solutions of this application.

Some of the concepts involved in the embodiments of this application are described below.

IM application: also referred to as IM software, is software that realizes online chat and communication through an IM technology. IM is a terminal service that allows two or more people to use a network to transmit text messages, files, voices, and videos for communication in real time.

Community: refers to a social network formed by a group of people or organizations in a specific field, interest, activity, or target. These people or organizations establish connections by sharing common values, interests, experiences, knowledge, and other interrelated factors to form a close social group. The community may be online, such as a social network, a forum, and a blog, or may be offline, such as an association, a club, and an organization. The community herein specifically refers to an online virtual organization including a large number of members around a particular interest or target.

Channel: refers to a large real-time online virtual community organization in chat software and may provide a one-stop channel operation platform for operators and diversified interest communication services for interest groups. The channel is a form of the community in this context.

Sub-channel: refers to a scene of different forms of communication and interaction among objects (for example, users) in a channel, such as a text sub-channel, a voice sub-channel, and a live streaming sub-channel. An administrator may create and delete sub-channels, edit sub-channel names, manage a visible range of sub-channels and grouping and sorting, and the like. The sub-channel is a form of a sub-community in this context. Each sub-community may represent a chat partition and includes members in the community.

Message list: refers to a page for viewing the latest message in an IM product. Usually, the message list is arranged in chronological order, with the latest message displayed at the top. The object may view more messages by scrolling the message list or turning pages. In the message list, the object may enter a personal home page or a related page of the object by clicking message content or an avatar for more interaction and understanding.

Message node: represents a message transmitter that transmits a message to a target object and notifies the target object of the message. Each message transmitter corresponds to one node. The message transmitter may be a friend of the target object as well as a group, a community, or the like associated with the target object. The message node in the embodiments of this application includes two types: an IM node and a community node. The IM node may be further classified into a C2C node and a group chat node. Taking the target object as an example, an IM node associated with the target object is a friend of the object or a group chat that the object joins, and each friend or group chat that the object joins corresponds to one IM node. The community node associated with the object represents a community that the object follows or joins.

Node identification: is configured for uniquely identifying one message node and may be specifically in the form of an avatar, a nickname, a community name, or the like. In the embodiments of this application, the node identification may alternatively be used as a chat entrance. The object may select a node identification in an interaction interface and view details of a message node corresponding to the node identification, for example, viewing a sub-community contained in the community node, viewing chat information corresponding to the IM node, and viewing a chat interface of the sub-community.

Real-time activity: refers to an ongoing activity. The sub-community in the community may irregularly or periodically organize an activity, such as a live streaming activity, a real-time voice activity, and a real-time game activity. For example, the real-time game activity includes voice communication that may be performed through a network when playing a game.

Text link: refers to a text-style link that supports jumping between interfaces. In the embodiments of this application, the text may refer to title information of a sub-community that generates a new message. That is, the title information is presented in a text link style so that a subsequent object may directly jump to a chat interface of the sub-community by operating the text link.

Abstract: refers to a summary or a content outline, meaning an excerpt of main points or an excerpted main point. Herein, the abstract specifically refers to a message abstract, and may be a latest message, a brief description of the latest message, or the like. If the abstract is a community node, the abstract may further include title information of a sub-community in the community. If the abstract is a group chat node or a community node, the abstract may further include a specific object publishing a message, and the like.

All in one (AIO): refers to that an object in a mobile phone version of chat software participates in many different types of sessions such as a friend, a group, and an official account. To provide unified interactive experience for objects, a chat window component shared by different sessions are provided in software, and behavior habits such as input and click operations of objects in the component may be considered to be consistent.

View data class (ViewModel): is responsible for preparing and managing data classes related to a user interface (UI) component (fragment/activity). That is, ViewModel is configured for managing UI-related data and may be further configured for being responsible for communication between UI components.

Virtual container (VC): is an information structure configured to support a channel layer connection. After various businesses are processed and loaded into the VCs, a system only needs to process the various VCs to achieve the purpose, regardless of a specific information structure. Therefore, good information transparency is provided, and the number of management entities is reduced.

A design idea of the embodiments of this application is briefly described below.

A large online community provides a more diversified group chat capability for social chats and breaks through the limitation of using a single chat session window as a unit in conventional IM chats. However, a large online community having a plurality of diversified chat windows, social content and interface hierarchies of chat windows are relatively deep, and there are significant differences in interaction manners between the community social interaction and IM social interaction. Currently, most community processing manners are separately processing IM and community social entrances. Existing community product form processing manners commonly include the following several types.

Type 1: a community list and a message list are separated on different pages using tabs. For example, when the object clicks a message identification in a category bar below a message interaction interface in an initial form, a message list detail page may be presented. When the object wants to view a community list page, the object needs to click a channel identification in the category bar to enter a community list detail page.

This processing manner is relatively simple. However, community social interaction and IM social interaction experience operations of the object are separated and are not coherent and natural enough, thereby reducing the message interaction efficiency.

Type 2: the community entrance is hidden in a menu entrance at an upper left corner of a home page in a form of an independent entrance, and the object needs to click multiple times to find a joined community, leading to low operation efficiency.

Similarly, when the object needs to return to a message list scene of IM from a community scene, the object also needs multiple tedious clicking operations to return to the message list scene.

In view of this, the embodiments of this application propose a community message interaction method and apparatus, an electronic device, and a storage medium. In this application, since message prompt information corresponding to the community node and the IM node may be displayed on the same message interaction interface simultaneously, different social entrances do not need to be set, and an object enters different social interfaces by selecting different social entrances, thereby effectively improving the viewing efficiency of social messages and saving computing resources and network resources. Further, the message interaction interface in this application has a dual form. When the object has a requirement for viewing a community message, the object may directly select the target community node in the message interaction interface so that the message interaction interface is switched from the initial form to the target form in which the community nodes associated with the target object are determined by screening, and node identifications of the community nodes and sub-communities contained in the target community node are displayed. In this manner, demands of IM and community chatting may be ensured simultaneously, and the object is convenient to access chatting content and activities that the object is interested in, thereby further improving the message interaction efficiency.

Some embodiments of this application are described below with reference to the accompanying drawings. The embodiments described herein are merely for illustrating and explaining this application and are not intended to limit this application. In addition, the embodiments and features of the embodiments in this application may be combined with each other without conflict.

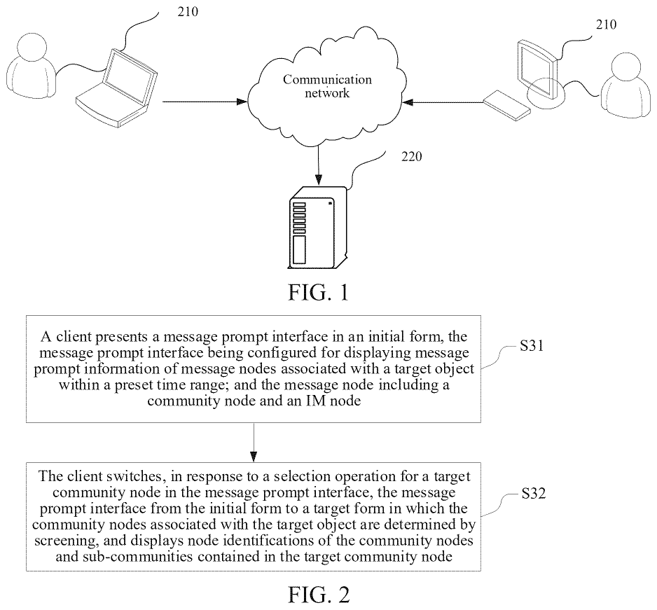

FIG. 1 is a schematic diagram showing an application scene according to an embodiment of this application. The application scene includes two terminal devices 210 and one server 220.

In this embodiment of this application, the terminal device 210 includes, but is not limited to, a mobile phone, a tablet computer, a notebook computer, a desktop computer, an e-book reader, an intelligent voice interaction device, an intelligent household appliance, an in-vehicle terminal, etc. A client related to community chatting and IM chatting may be installed on the terminal device. The client may be software (such as a browser or chat software), or may be a web page, a mini program, or the like. The server 220 is a background server corresponding to software, a web page, a mini program, or the like, or is a server specifically configured to manage community chatting and IM chatting. This is not specifically limited in this application. The server 220 may be an independent physical server, may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform.

The community message interaction method provided in the embodiments of this application may be performed by an electronic device. The electronic device may be the terminal device 210 or the server 220. That is, the method may be performed by the terminal device 210 or the server 220 alone or may be performed by the terminal device 210 and the server 220 together. For example, when the method is performed by the terminal device 210 alone, the terminal device 210 may be installed with chat software, and the chat software supports both the IM chatting and the community chatting. Specifically, a message interaction interface in the chat software has a dual form, including an initial form and a target form. In the initial form, the message interaction interface may display message prompt information of various message nodes (including the community node and the IM node). In the initial form, the object may select an IM node, view a chat interface of the IM node, and further select a community node. Further, the message interaction interface is switched from the initial form to a target form in which community nodes, determined by screening, associated with a target object are presented, and node identifications of the community nodes and sub-communities contained in a target community node are displayed.

In an implementation, the terminal device 210 may communicate with the server 220 through a communication network.

In an implementation, the communication network is a wired network or a wireless network.

FIG. 1 is merely an example for description. Actually, the numbers of terminal devices and servers are not limited and are not specifically limited in this embodiment of this application.

In this embodiment of this application, when there are a plurality of servers, the plurality of servers may be grouped into a blockchain, and the servers are nodes on the blockchain. According to the community message interaction method disclosed in the embodiments of this application, involved message data, object operation data, and the like may be stored in the blockchain, for example, message prompt information, community detail information, and related messages of the message nodes.

In addition, this embodiment of this application may be applied to various scenes, including but not limited to, cloud technology, artificial intelligence, intelligent transportation, and assisted driving.

The community message interaction method provided in the exemplary implementations of this application is described below with reference to the foregoing described application scene and the accompanying drawings. The foregoing application scene is merely shown for ease of understanding the spirit and principle of this application, and the implementations of this application are not limited in this aspect.

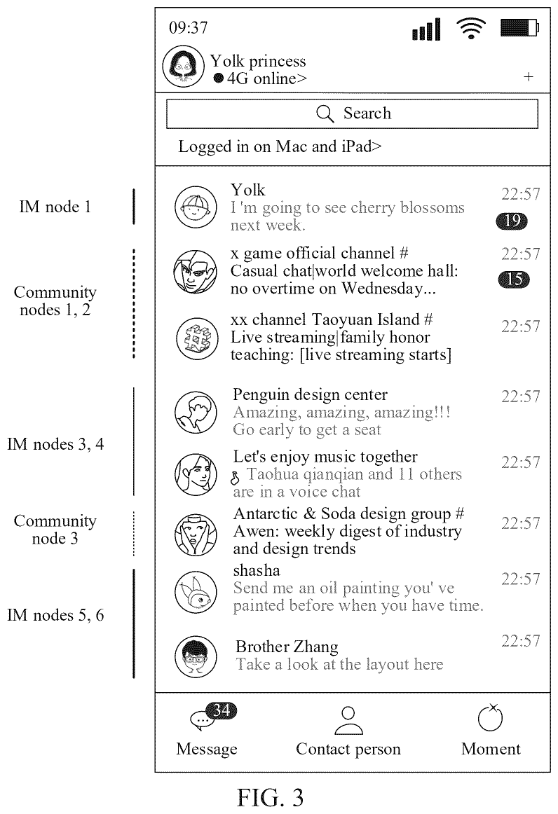

FIG. 2 is an implementation flowchart of a community message interaction method according to an embodiment of this application. Taking a client as an execution subject as an example, a specific implementation procedure of the method is as follows.

S31: the client presents a message interaction interface in an initial form, the message interaction interface displaying a plurality of message nodes associated with a target object, and the plurality of message nodes includes one or more community nodes and one or more IM nodes.

The message interaction interface in this embodiment of this application is an interaction interface that effectively integrates community social interaction and IM social interaction. The interaction interface may display message prompt information of the community node and message prompt information of the IM node simultaneously.

IM is a messaging manner that allows two or more people to use a network to transmit text messages, files, voices, and videos for communication in real time. Each IM node may represent a C2C node or a group chat node.

The community refers to an online virtual organization including a large number of members around a particular interest or target, and includes but is not limited to: a channel, an official account (such as a subscription account), and the like.

A channel is a large real-time online virtual community organization provided in chat software and may provide a one-stop channel operation platform for operators and diversified interest communication services for interest groups. Each channel may include one or more sub-channels. A channel may be divided into sub-channels according to scenes of different forms of communication and interaction among objects in the channel, such as a text sub-channel, a voice sub-channel, and a live streaming sub-channel. An administrator may create and delete sub-channels, edit sub-channel names, manage a visible range of sub-channels and grouping and sorting, and the like.

The official account is another virtual community organization that is provided in chat software and uses a public account platform to perform a one-to-many media behavior activity. It may provide media information for the public and includes an account type shown below:
subscription account: providing a new information propagation manner for media and individuals, and establishing a better communication and management mode with readers.

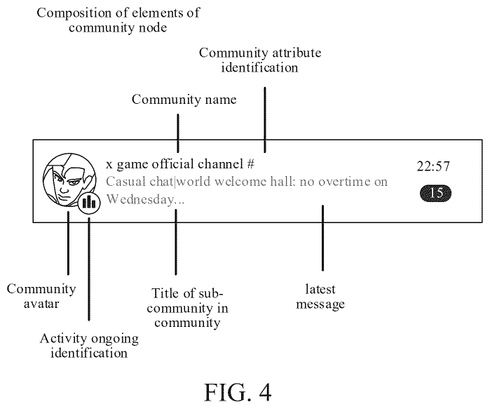

FIG. 3 is a schematic diagram showing a message interaction interface in an initial form according to an embodiment of this application. The interface lists message prompt information of several message nodes: C2C, group chat, and channel. The C2C and group chat are both IM nodes, and the channel is a community node.

The message interaction interface is presented in a form of a message list of a message flow. The message flow is a data form that continuously provides content to a user. The user actively subscribes to a message source (for example, the message source is a message node in this application), and the content is provided to the user according to the message source to which the user subscribes. The message nodes are sorted in the message list according to the delivery time of latest messages of the message nodes. For example, the latest message and the message node corresponding to the latest message are displayed on the top of the message list. The target object may view more messages by scrolling or page turning. In the message list, the target object may enter a personal home page or a related page of an object corresponding to a message node by clicking message content or an avatar of the message node for more interaction and understanding.

In all embodiments, when each message node is displayed in the message interaction interface, message prompt information of each message node may be displayed. The message prompt information includes, but is not limited to: a node identification (for example, an avatar and a nickname/a community name) of the message node, a message abstract, the number of unread messages, and message receiving time.

A node identification of a first message node (i.e., an IM node 1) in FIG. 3 includes an avatar and a nickname (for example, “yolk”). In addition, message prompt information of the first message node further includes a message abstract, for example, “I'm going to see cherry blossoms next week”; message receiving time, for example, 22:57; and the number of unread messages, for example, 19. For another example, a node identification of a second message node (community node 1) in FIG. 3 includes an avatar and a community name (for example, “x game official channel”). In addition, message prompt information of the second message node further includes a message abstract, for example, “casual chat|world welcome hall: no overtime on Wednesday”; message receiving time, for example, 22:57; and the number of unread messages, for example, 15.

The message prompt information of a plurality of message nodes displayed on the message interaction interface may be within a preset time range. The preset time range may be determined according to an actual requirement and is not specifically limited herein. The preset time range may further reflect a refresh rate of the message interaction interface, for example, refreshing once every one second or refreshing once every ten seconds.

In this embodiment of this application, one community may contain several sub-communities. In this embodiment of this application, the sub-communities may be understood as a plurality of chat partitions obtained by further dividing the community. For example, in a community, a community owner or an administrator may create chat partitions for interaction with objects, such as a text chat sub-community, a post sub-community, a real-time voice sub-community, and a live streaming sub-community. The text chat, post, real-time voice, live streaming, and the like listed above belong to different interaction themes. The real-time voice, live streaming, real-time game, and the like also belong to real-time activities.

In the community node, in addition to displaying chat message content, when an important real-time activity occurs, prompt information related to the activity may be further displayed to represent a current activity state, for example, an ongoing state identification. An implementation is as follows.

In the message interaction interface in the initial form, when any community node has a real-time activity, the message prompt information of the community node further includes: an ongoing state identification corresponding to a real-time activity whose priority is in a specified level. For example, when a plurality of message nodes associated with the target object is displayed, if a community node in one or more community nodes has one or more first real-time activities, first message prompt information of the community node may be displayed on the message interaction interface. The first message prompt information includes: an ongoing state identification corresponding to a first real-time activity whose priority among the one or more first real-time activities is in a first specified level. In some embodiments, the priority being in the specified level or the priority being in the first specified level refers to that the priority is the highest, i.e., the specified level or the first specified level is the highest priority.

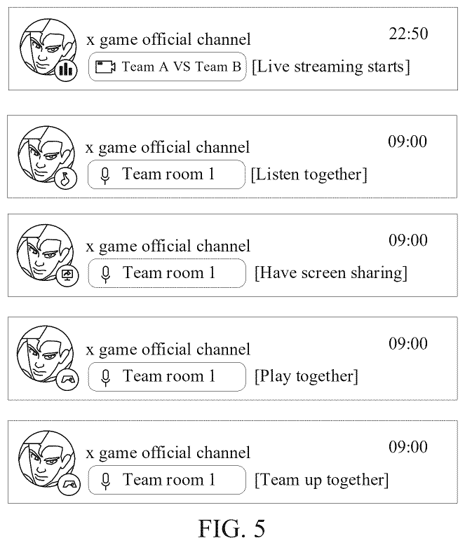

FIG. 4 is a schematic diagram showing the composition of elements of a community node according to an embodiment of this application. The elements of the community node include information such as a community name, a community attribute identification, a community avatar, an activity ongoing identification (which may be in a form of an icon, an animation, etc.), a title of a sub-community in a community, and a latest message. The community node in this embodiment of this application may further be suffixed with a community attribute identification “#” after the community name to intuitively distinguish from the IM node.

In FIG. 4, an ongoing state icon corresponding to a (real-time) activity with the highest priority is displayed at a lower right corner of the community avatar.

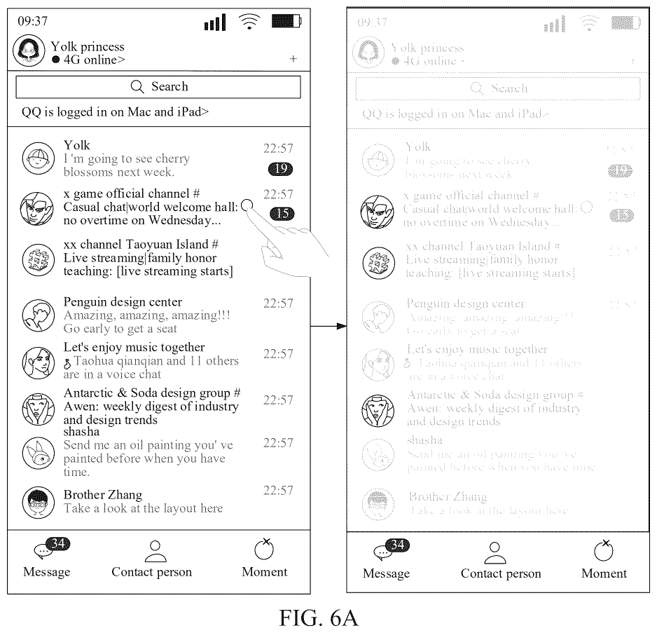

FIG. 5 is a schematic diagram showing ongoing state identifications of some activities according to an embodiment of this application. In FIG. 5, several activities such as live streaming, listening together, screen sharing, playing together, and teaming up together as well as their corresponding ongoing state icons are listed and displayed at the lower right corners of the community avatars.

Although FIG. 5 is an example of different types of activities corresponding to different ongoing state icons, the display styles (including positions, font colors, and the like) of the ongoing state identifications listed in FIG. 4 or FIG. 5 are merely simple examples. Any display style is applicable to this embodiment of this application and is not specifically limited herein.

Based on the foregoing implementations, embodiments of this application propose an interaction manner that integrates a large community and an IM message flow. The community, as a type of a message service, appears together with an IM message node in a message list of a message flow of an object in a manner of a message node. In this manner, the immediacy of community interaction is improved. Meanwhile, it is beneficial for the object to efficiently and quickly view a community chatting activity that the object is interested in.

S32: the client switches, in response to a selection operation for a target community node of the one or more community nodes, the message interaction interface from the initial form to a target form in which at least one community node associated with the target object is determined by screening, the target form displaying a node identification of the at least one community node and at least one sub-community contained in the target community node. The community node determined by screening is also referred to as a “screened community node.” The at least one community node includes the target community node.

When the target object clicks the target community node in the message list, the message list is converted from an initial list form into the target form in which the community node determined by screening is displayed. A sub-community list of the selected target community node is expanded by default so that the target object may understand the full view of the sub-communities of the target community node more intuitively and efficiently.

When the initial form is switched to the target form, the message interaction interface may only display the node identification of at least one screened community node associated with the target object and at least one sub-community contained in the target community node and does not include information of the IM node. The at least one screened community node associated with the target object may be one or more community nodes displayed in the initial form, or may be a part of the one or more community nodes, or may further include, in addition to the one or more community nodes, other community nodes that are associated with the target object but cannot be displayed in the initial form due to the size of the display screen of the terminal device.

In this embodiment of this application, the target form may alternatively be referred to as an expanded form and represents a form in which community nodes among the message nodes associated with the target object are determined by screening, expanded, and presented. Alternatively, the target form is referred to as a sidebar form, representing that the screened community node is presented in a sidebar part of the message interaction interface, or the like.

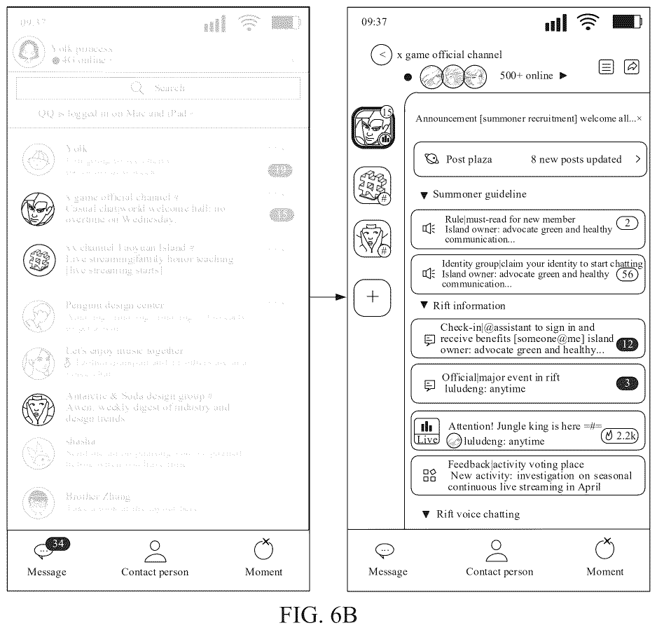

When the message interaction interface is converted from the initial form into the target form, transition may be performed in a page transition manner shown in FIG. 6A, and the current message list is changed into a community expanded form structure to present the message interaction interface in the target form shown in the right figure of FIG. 6B.

FIG. 6A is a schematic diagram showing a page transition according to an embodiment of this application. FIG. 6A shows that when the target object selects a community node 1 (an x game official channel) as a target community node in the message interaction interface in the initial form, the client may screen message nodes associated with the target object to determine community nodes therein.

Further, when the community nodes are determined by screening, node identifications of the community nodes are displayed in the message interaction interface in the target form, and sub-communities contained in the target community node are expanded and presented. FIG. 6B is a schematic diagram showing another page transition according to an embodiment of this application. FIG. 6B shows that three community nodes associated with the target object are determined by screening to present the message interaction interface in the target form shown in the right figure of FIG. 6B, where node identifications of the three community nodes are in the form of community avatars. In addition, the community avatar of the target community node-the community node 1 presents a “selected state.” As shown in FIG. 6B, the community node 1 is distinguished from other community nodes by a bold rounded rectangular frame around its avatar to indicate the “selected state.” In addition, a sub-community list of sub-communities contained in the community node 1 “x game official channel” is further displayed, such as “rule|must-read for new member,” “identity group|claim your identity to start chatting,” “check-in|@assistant to sign in and receive benefits,” “official|major event in rift,” “attention! jungle king is here =#=,” and “feedback|activity voting place” shown in FIG. 6B.

The sub-communities of the target community node may be arranged in the sub-community list in a fixed order or may be sorted according to the delivery time of the latest messages. For example, a sub-community having a latest message is displayed on the top of the sub-community list. Any sub-community arrangement manner is applicable to this embodiment of this application and is not specifically limited herein.

Based on the foregoing implementation, the object clicks the target community node, the message list is converted from the initial list form into the target form in which the community nodes are determined by screening, and the sub-community list of the selected target community node is expanded by default so that the object may intuitively understand the full view of sub-communities of the community node without too many interface operations, thereby improving the message interaction efficiency. The form conversion manner is processing of different forms performed on the message list so that processing logic of an interface is more coherent, and computing resources are fully used.

In some embodiments, when any community node has a real-time activity in the target form, a related position of a node identification of the any community node further displays: an ongoing state identification corresponding to a real-time activity whose priority is in a specified level. For example, when the node identification of at least one community node is displayed, if a community node in the at least one community node has one or more second real-time activities, an ongoing state identification corresponding to a second real-time activity whose priority among the one or more second real-time activities is in a second specified level may be displayed at a related position of a node identification of the community node on the message interaction interface. In some embodiments, the priority being in the specified level or the priority being in the second specified level refers to that the priority is the highest, i.e., the specified level or the second specified level is the highest priority.

As shown in FIG. 6B, the foregoing listed sub-community “attention! jungle king is here” is live, that is, the community node 1 “x game official channel” has a live streaming activity. In this case, an ongoing state identification of the live streaming may be displayed at the lower right corner of a community avatar of the community node. The related position of the node identification of the community node is the lower right corner of the community avatar of the community node.

In addition, an upper right corner of the community avatar of the community node 1 may further display the number of unread messages, such as 15 shown in FIG. 6B.

An example in which the community node 1 has only one real-time activity is used above. In this case, the real-time activity whose priority is in the specified level is this real-time activity. If the community node 1 has a plurality of real-time activities, an ongoing state identification of an activity with the highest priority among the plurality of real-time activities may be displayed.

Taking a plurality of real-time activities as an example, each real-time activity corresponds to one sub-channel. If these real-time activities exist simultaneously, when priorities of the activities are determined, the priorities may be sorted according to one or more priority determining conditions such as a joining state of the target object and whether the sub-channel belongs to a finely selected sub-channel.

For example, a priority of a sub-channel that the target object has joined is higher than a priority of a sub-channel that the target object has not joined. Further, for the sub-channels that the target object has joined, a priority of a sub-channel belonging to the finely selected sub-channel is higher than a priority of a sub-channel not belonging to the finely selected sub-channel. Similarly, for the sub-channels that the target object has not joined, a priority of a sub-channel belonging to the finely selected sub-channel is higher than a priority of a sub-channel not belonging to the finely selected sub-channel.

Based on the foregoing rule, the following four sub-channels having real-time activities are sorted: a sub-channel 1 (not joined and finely selected), a sub-channel 2 (joined and not finely selected), a sub-channel 3 (not joined and not finely selected), and a sub-channel 4 (joined and finely selected). A sorting result is: the sub-channel 4>the sub-channel 2>the sub-channel 1>the sub-channel 3. The sub-channel 4 has the highest priority.

The foregoing listed priority determining manner is merely a simple example. Any determining manner is applicable to this embodiment of this application and is not specifically limited herein.

In the foregoing implementation, through the embodiment of the ongoing state identifications of the real-time activities, the object may understand the states of the activities in a community more intuitively, thereby improving the interaction efficiency.

In the message interaction interface in the target form, the object may further click different sub-communities (i.e., sub-communities) in a community and enter corresponding AIO for chatting and interaction. An implementation is as follows.

Jump, in response to a selection operation for a first sub-community of the at least one sub-community, the message interaction interface to a chat interface of the first sub-community.

Based on the foregoing implementation, the object may click different sub-communities (i.e., sub-communities) in a community to enter corresponding AIO for chatting and interaction.

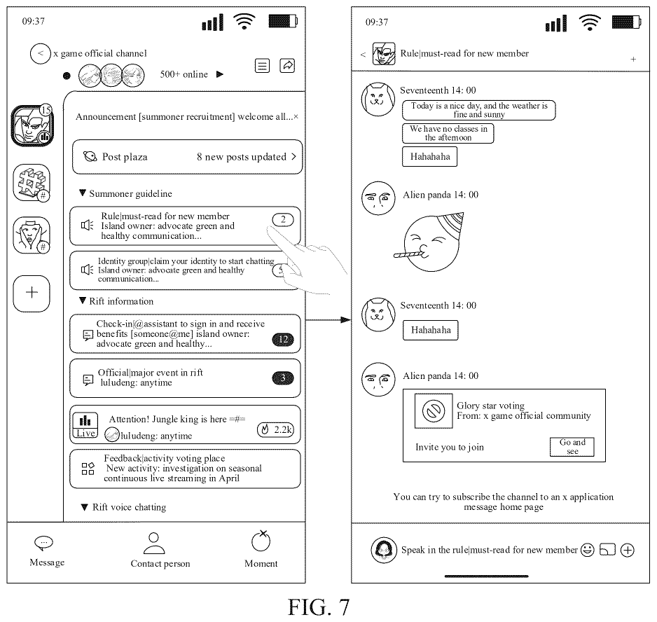

FIG. 7 is a schematic diagram showing a chat interface of a sub-community according to an embodiment of this application. FIG. 7 shows that the target object selects, from the sub-communities contained in the target community node “x game official channel,” “rule|must-read for new member,” i.e., the first sub-community in a plurality of embodiments of this application. Through this selection, the message interaction interface may jump to a chat interface shown in the right figure of FIG. 7, where the target object may speak.

In addition, the target object may further view, in a community framework area by sliding down, other sub-communities that are not temporarily displayed.

In the foregoing implementation, the sub-communities contained in the target community node may be displayed in the message interaction interface in the target form to strengthen a tree-like structure of the sub-communities of the community node so that the object may intuitively and globally understand all chat topics and entrances covered by a community, thereby highlighting a social advantage of multi-topic and multi-grouping of a large community, and improving the community message interaction efficiency. On this basis, the object may select any sub-community. In this way, the object may enter the corresponding AIO for chatting and interaction.

In this embodiment of this application, the target object may further quickly and directly reach the AIO through the community node in the message interaction interface in the initial form. An implementation is as follows.

When a new message is generated in sub-communities of any community node, message prompt information of the any community node includes: title information, presented in a text link style supporting interface jumping, of the sub-communities that generate the new message. For example, when a new message is generated in sub-communities of a community node in the one or more community nodes, second message prompt information of the community node is displayed on the message interaction interface, and the second message prompt information includes: title information, presented in a text link style supporting interface jumping, of the sub-communities that generate the new message.

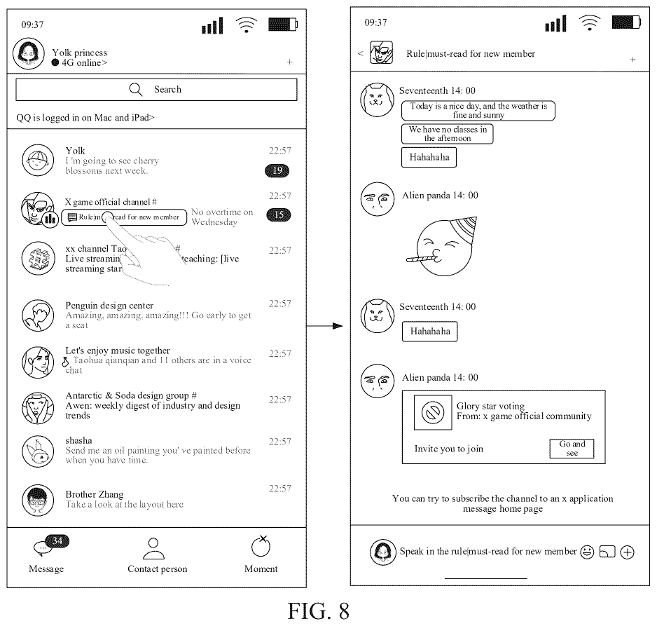

FIG. 8 is a schematic diagram showing a sub-community title information in a text link style according to an embodiment of this application. For example, in the left figure of FIG. 8, the sub-community title information “rule|must-read for new member” in a text link style is highlighted in a bold manner. In the message interaction interface (as shown in the left figure of FIG. 8) in the initial form, for a community node, a text link may be presented in a manner listed in the left figure of FIG. 8, and the target object may quickly view a chat interface (as shown in the right figure of FIG. 8) of a sub-community corresponding to the text link directly through the text chain.

In addition, the text link may be presented in a highlighting manner such as brightening. This is not specifically limited herein.

For example, when new chat content appears in a community node, a sub-community title to which the new chat content belongs will have a brightening effect in the text link style. In this case, the corresponding AIO may be directly reached by clicking the text link to perform quick message processing.

Based on the foregoing description, in response to a trigger operation for title information of a second sub-community of the sub-communities that generate the new message, the client may directly jump from the message interaction interface to a chat interface of the second sub-community. As shown in the right figure of FIG. 8, the right figure is a schematic diagram showing a chat interface of a second sub-community according to an embodiment of this application. The target object may perform quick message processing based on this manner, and form switching does not need to be performed on the message interaction interface. The distinction between the first sub-community and the second sub-community is merely for ease of description, and the first sub-community and the second sub-community may be the same or different.

Further, after performing quick processing on a message in a sub-community (for example, the second sub-community), the target object may further return to the message interaction interface in the initial form. An implementation is as follows.

The client returns to the message interaction interface in the initial form in response to a return operation triggered through the chat interface of the second sub-community, and switches the title information of the second sub-community from the text link style to an abstract style that does not support jumping.

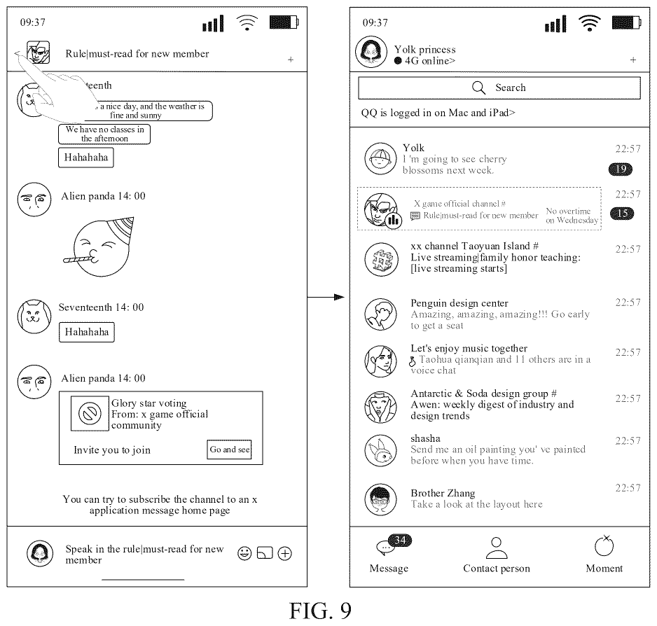

FIG. 9 is a schematic diagram showing an interface return process according to an embodiment of this application. As shown in the left figure of FIG. 9, the target object clicks a return button “<” at an upper left corner of a chat interface of a sub-community “rule|must-read for new member” so that the chat interface may be returned to the message interaction interface in the initial form shown in the right figure of FIG. 9. In the message interaction interface, title information of “rule|must-read for new member” is restored from a text link style to an ordinary gray abstract style, and clicking for jumping is no longer supported.

Through the foregoing implementation, the object may quickly view chats and activities in different communities, thereby improving the community message interaction efficiency.

Hereinafter, a layout of the message interaction interface in the target form proposed by this embodiment of this application will be described as an example.

In this embodiment of this application, the message interaction interface in the target form includes a title area, a message node identification area, and a community framework area. The title area, the message node identification area, and the community framework area may be referred to as a first area, a second area, and a third area, respectively. An implementation is as follows. Title information of the target community node is displayed in the title area, node identifications of the community nodes are displayed in the message node identification area, and the sub-communities contained in the target community node are displayed in the community framework area. Presenting a node identification of at least one community node and at least one sub-community contained in the target community node includes: displaying the title information of the target community node in the first area, displaying the node identification of the at least one community node in the second area, and displaying the at least one sub-community contained in the target community node in the third area.

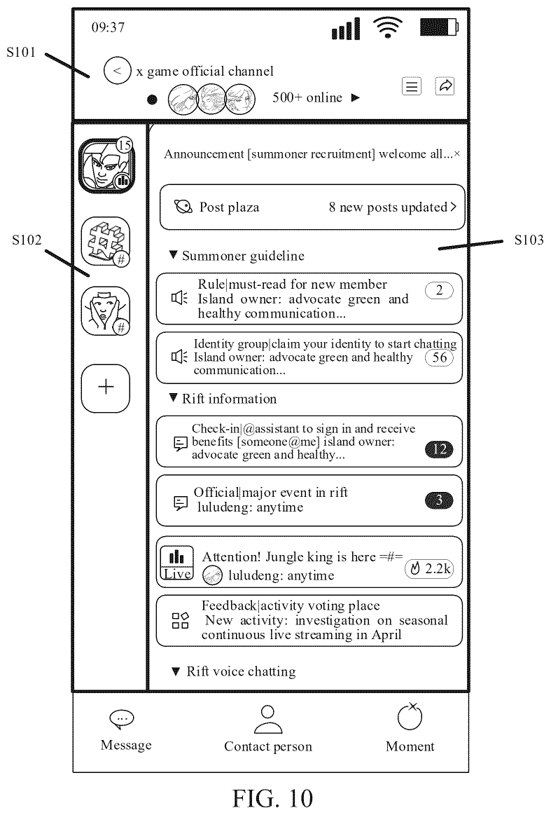

FIG. 10 is a schematic diagram showing a message interaction interface according to an embodiment of this application. The message interaction interface includes a title area S101, a message node identification area S102, and a community framework area S103. Title information of a current target community node-community node 1 “x game official channel” is displayed in the title area S101, and information such as avatars and number (500+) of current online members in the community node is further displayed. In addition, a background of the title area S101 may be an image related to the community node. The node identifications of the community nodes are displayed in the message node identification area S102, and at a related position of the node identification, at least one of the following may be further displayed: the number of unread messages, and an ongoing state identification corresponding to the real-time activity. As shown in FIG. 10, an ongoing state identification of live streaming is displayed at a lower right corner of the community avatar of the community node 1, and the number of unread messages 15 is displayed at an upper right corner. Sub-communities of the target community node-community node 1 “x game official channel” are displayed in the community framework area S103.

Since the message node identification area S102 is located on a side edge of the message interaction interface and presented in a form of a sidebar, the target form may further be referred to as a sidebar form.

The layout manner of the areas listed in FIG. 10 is merely a simple example. Any layout manner is applicable to this embodiment of this application and is not specifically limited herein. In the accompanying drawings of all embodiments of this application, the division of areas in a layout similar to that in FIG. 10 may refer to FIG. 10. Based on the area layout listed in the foregoing implementation, the logic of the message list may be reused without recreating an avatar list and additionally processing logic such as message sorting and updating, thereby saving computing resources.

Since the message interaction interface in the target form includes node identifications of community nodes associated with the target object, the target object may further perform community switching through these node identifications to switch from a community to another community for viewing. An implementation is as follows.

The client responds to a community switching operation triggered through a node identification in the message node identification area to switch to a community node corresponding to the node identification, switches the title area to present title information of the community node corresponding to the node identification, and switches the community framework area to present sub-communities contained in the community node corresponding to the node identification. In a case that the title area, the message node identification area, and the community framework area are the first area, the second area, and the third area, respectively, responding to the community switching operation triggered through a node identification in the second area to switch to the community node corresponding to the node identification, the first area is switched to display title information of the switched community node, and the third area is switched to present at least one sub-community contained in the switched community node.

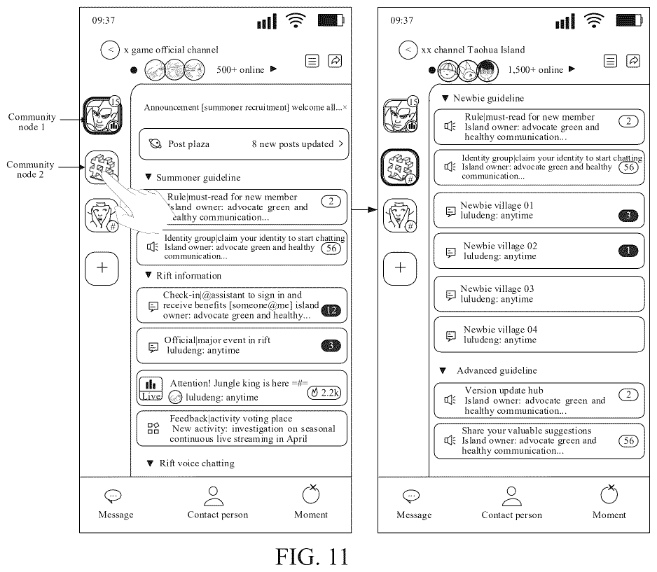

FIG. 11 is a schematic diagram showing a community switching process according to an embodiment of this application. In a left interface in FIG. 11, three community nodes are displayed in a message node identification area located at a side edge of a message interaction interface. A community node 1 is a community node whose message is currently viewed by a target object and may be referred to as a current community node. Related information of the community node 1 is displayed in a title area and a community framework area of the message interaction interface. When the target object triggers a community switching operation by clicking an avatar (a node identification) of a community node 2, the client responds to the operation and switches to an interface shown in the right side of FIG. 11. Compared with the interface shown in the left side of FIG. 11, the title area in the right side of FIG. 11 is updated from title information of the community node 1 to title information of the community node 2, and the community framework area also presents sub-communities contained in the switched community node 2, such as “rule|must-read for new member,” “identity group|claim your identity to start chatting,” “newbie village 01,” “newbie village 02,” “newbie village 03,” “newbie village 04,” “version update hub,” and “share your valuable suggestions” that are listed in FIG. 11.

In addition, the title area may further display a community-related background picture. The background picture also changes as communities switch. This is not specifically limited herein.

In some embodiments, when community switching is performed, the following animation may further be presented to the object to emphasize the community switching to the object:
displaying the node identification of the switched community node through a preset zoom animation, where the preset zoom animation represents that the node identification of the switched community node is zoomed out from an original scale to a target scale and then zoomed in from the target scale to the original scale.

For example, in an expanded form (in the target form), when another community node that is not the current community node is clicked in the message node identification area on the side edge of the message interaction interface to switch to the community node, all elements (including a message red dot, a selected state, an activity identification at a lower right corner, a corner mark, and the like) on an avatar of the switched community node may be linked together to form a preset zoom animation. For example, the preset zoom animation represents zooming out from scale 1.0 to 0.9 and then zooming in from 0.9 to 1.0, and the duration is 0.15 s. A pixel has two attributes, one is a value of the pixel, and the other is a coordinate of the pixel. The value of the pixel records intensity information of the pixel, and the coordinate of the pixel records spatial information of the pixel. A scale operation is performed on the coordinate of the pixel, i.e., scaling a coordinate of an image, equivalent to zooming out and in the image. The scale operation listed above represents a process in which the node identification of the switched community node is zoomed out from the original scale to the target scale and then zoomed in from the target scale to the original scale.

Specifically, the foregoing animation may be implemented through easeInEaseOut provided by a system as a time buffer function, using a frame-by-frame animation (CADisplayLink) timer that continuously calls back progress according to a screen refresh rate, with each element setting the scale of its layer according to the real-time progress.

When the scale is set, an implicit animation of the system may be disabled. If the implicit animation is not disabled, the system has a zoom animation for the layer. In addition, the scale belongs to an animation attribute of the layer, and if the scale is directly set, there will be an animation. Therefore, an implicit animation of the system is disabled, and the scale may be directly set.

On this basis, the object may further view the sub-communities in the switched community.

The client presents, in response to a selection operation for a third sub-community of the at least one sub-community contained in the switched community node, a chat interface of the third sub-community.

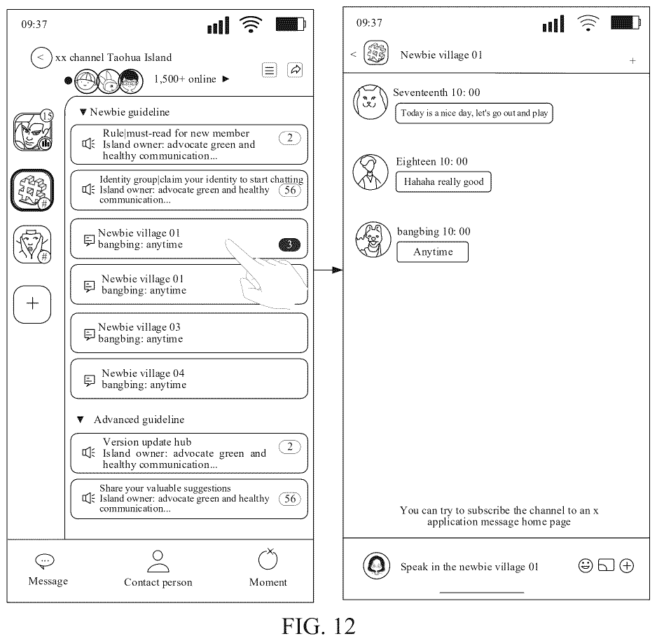

FIG. 12 is a schematic diagram showing a sub-community viewing process after community switching according to an embodiment of this application. For example, after the target object selects the sub-community “newbie village 01” in the left figure of FIG. 12 as the third sub-community, the message interaction interface in the target form in the left figure of FIG. 12 may jump to the chat interface of “newbie village 01” shown in the right figure of FIG. 12, where the target object may speak.

In addition, the target object may further view, in a community framework area by sliding down, other sub-communities that are not temporarily displayed.

In this embodiment of this application, the sidebar form integrates some chat entrances related to the community node, and the target object may quickly find community nodes of other joined communities in the sidebar except the current community node for switching and viewing. Through the community switching, chats and activities of different sub-communities contained in the switched community may further be quickly viewed.

In this embodiment of this application, the message interaction interface in the target form may further include a community discovery entrance, and more communities that the target object may join may be discovered through the community discovery entrance. An implementation is as follows.

The client switches to a community discovery interface in response to a trigger operation for the community discovery entrance and presents the node identifications of the community nodes and at least one recommended community in the community discovery interface

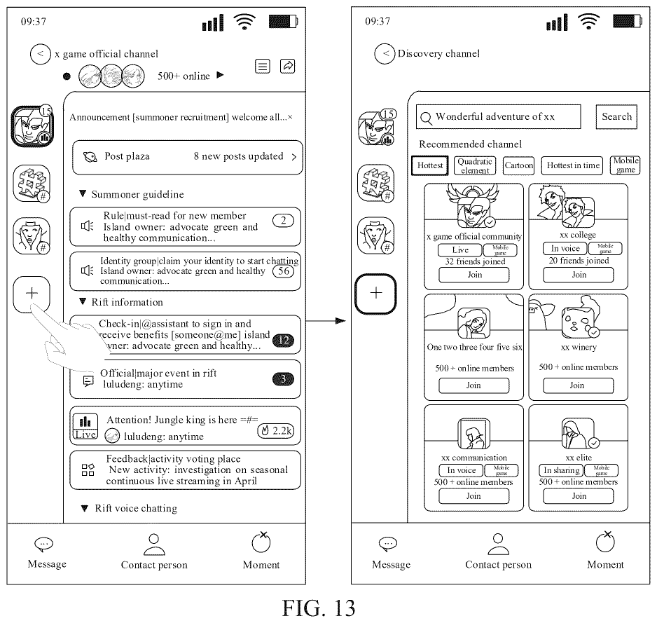

FIG. 13 is a schematic diagram showing a community discovery interface according to an embodiment of this application. In addition to displaying avatars of the community node 1, the community node 2, and the community node 3 in a node identification area in the left figure of FIG. 13, a “plus sign entrance” is further displayed below the avatar of the community node 3. The plus sign entrance is a community discovery entrance exemplified in this embodiment of this application. When the target object clicks the plus sign entrance, the client, in response to a trigger operation for the community discovery entrance, switches from a message interaction interface shown in the left figure of FIG. 13 to a community discovery interface shown in the right figure. In the right figure of FIG. 13, a plurality of recommended communities are listed in the community discovery interface.

The message interaction interface in the target form includes a title area, a message node identification area, and a community framework area. A layout of the community discovery interface may be the same as that of the message interaction interface in the target form listed in the foregoing embodiments (as shown in FIG. 10). That is, the community discovery interface may further include a title area, a message node identification area, and a community framework area. Node identifications of community nodes that the target object has joined or associated with continues to be displayed in the message node identification area in the community discovery interface. The community framework area is configured for displaying at least one recommended community, and a “discovery channel” is displayed in the title area as title information corresponding to the interface.

Recommended communities (i.e., recommended channels) listed in FIG. 13 include “x game official community,” “xx college,” “one two three four five six,” “xx winery,” “xx communication,” “xx elite,” and the like. The target object may slide up and down in the community framework area to view more recommended communities, and select one or more to join. Alternatively, the target object searches for other communities that the target object wants to join in a targeted manner through a search bar in the community framework area.

In some embodiments, the client adds, in response to a join operation for a target recommended community of the at least one recommended community, a node identification of a community node corresponding to the target recommended community in the community discovery interface.

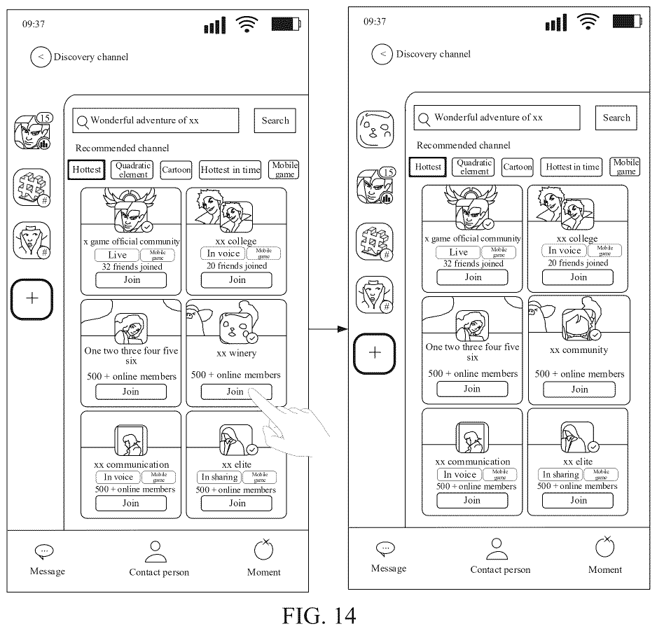

FIG. 14 is a schematic diagram showing a community addition process according to an embodiment of this application. The left figure of FIG. 14 represents that the target object selects a target recommended community “xx winery” and clicks a “join” button corresponding to the community, and the client, in response to a join operation for the target recommended community, presents an interface shown in the right figure of FIG. 14. Compared with the left figure of FIG. 14, a node identification of the target recommended community “xx winery” is newly added to the message node identification area. As shown in the left figure of FIG. 14, an avatar of “xx winery” is newly added above an avatar of an original community node 1 “x game official channel.”

In this embodiment of this application, the target object may join more communities through the community discovery entrance, which may help the target object quickly reach more chatting about interested content in scenes of spending time and browsing around, and community social scenes are connected.

In an implementation, to realize more natural switching between the message interaction interface and the community discovery interface, this application further provides the following switching animation:
the client controls, in response to a trigger operation for the community discovery entrance, the message interaction interface in the target form to switch to the community discovery interface by executing a switching animation representing that the community framework area in the message interaction interface in the target form fades out and the community framework area in the community discovery interface fades in.

For example, in the expanded form, the target object clicks a plus sign icon. For example, in FIG. 13, a community list view (i.e., the community framework area of the message interaction interface) on the right side of the left interface and a discovery page view (i.e., the community framework area of the community discovery interface) on the right side of the right interface make a fade-out and fade-in animation. The animation uses CABasicAnimation provided by an iOS system and uses alpha as a keypath, with a Bezier curve of control points (0.38, 0.7) and (0.125, 1.0) as a timing function.

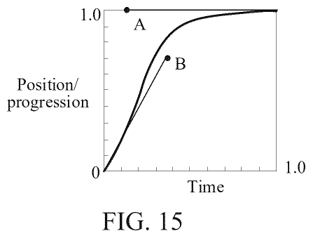

A Bezier curve is a mathematical curve applied to a two-dimensional graphic application program and includes a line segment and a node. The node is a draggable fulcrum, and the line segment is like a retractable rubber band. The curve is defined with four points: a starting point, an end point (also referred to as an anchor point), and two intermediate points that are separated from each other. When the two intermediate points are slid, the shape of the Bezier curve changes. FIG. 15 is a schematic diagram showing a Bezier curve according to an embodiment of this application. (0, 0) is a starting point, (1.0, 1.0) is an end point, and (0.38, 0.7) and (0.125, 1.0) are intermediate points, i.e., control points. In FIG. 15, a point A represents the control point (0.125, 1.0), and a point B represents the control point (0.38, 0.7). The two control points A and B are not points on the Bezier curve, but are control points for determining the shape of the Bezier curve. A Bezier curve determined based on the two control points is shown in FIG. 15.

Further, when a new message is generated by at least one IM node associated with the target object, a temporary node identification of the at least one IM node that generates the new message may further be presented in the message node identification area (the second area).

For example, when the display screen displays the message interaction interface in the target form, if a new IM message for the target object is generated, for example, a friend A and a friend in a group B of the target object each transmit a new message to the target object, node identifications (for example, a friend avatar and a group chat avatar) of the friend A and the group B may be further additionally displayed in the message node identification area in the message interaction interface, and message red dots (representing the number of unread messages) may be further presented. The node identification of the IM node presented in this case has a temporary attribute, i.e., temporarily presented in the message interaction interface in the target form. After the target object views the corresponding new IM message, the temporary node identification may disappear, i.e., no longer presented, and may be presented again when there is a new message subsequently.

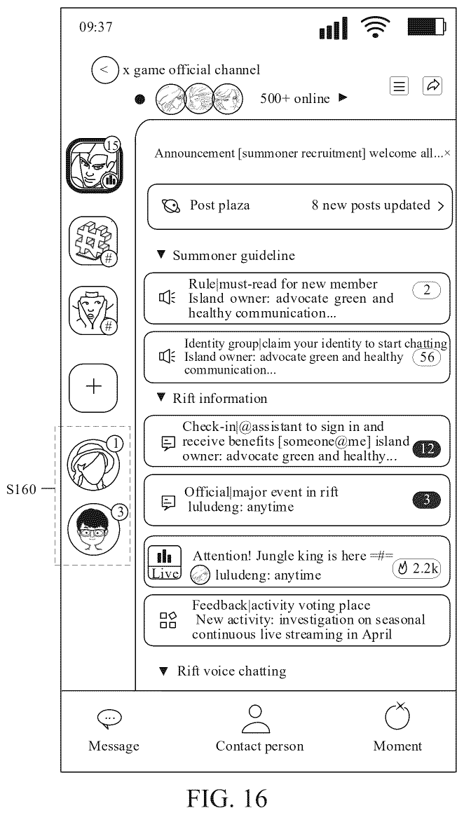

FIG. 16 is a schematic diagram showing a temporary node identification of an IM node according to an embodiment of this application. As shown in a dashed box S160 in FIG. 16, the content in the dashed box is an example of a temporary node identification of an IM node listed in this application. The temporary node identification is a friend avatar, and the number of unread messages is further displayed at an upper right corner of the avatar. For example, in S160, one unread message and three unread messages are separately represented.

In a case that the temporary node identifications of the IM nodes are displayed, the target object may view chat information of corresponding IM nodes based on these temporary node identifications. An implementation is as follows.

The client presents, in response to a trigger operation for a temporary node identification of a target IM node in the at least one IM node, chat information of the target IM node.

In this embodiment of this application, when the target form of the message list is presented on the display screen, if a new IM message is generated, a C2C avatar, a group chat avatar, and a message red dot may additionally appear in the sidebar. The target object may quickly click the avatar to display the latest chat dialog through a chat window for the target object to view.

Specifically, the foregoing chat window may be displayed through a technology of directly pushing one ViewController on a current stack to cover the message interaction interface in the target form. Returning will still bring back to the target form, thereby enabling quick and convenient switching among various chat scenes.

The ViewController is an important part of an iOS application program and an important bridge between application program data and views. The ViewController manages multiple views in the application.

In this embodiment of this application, there are multiple manners of presenting the chat information of the target IM node, which include but are not limited to the following two manners.

Manner 1: The community framework area in the target form is switched from displaying at least one sub-community to displaying the chat information of the target IM node.

This manner represents that the corresponding chat information is directly presented in the current message interaction interface in the target form. In this manner, the logic of the message list may be effectively reused, computing resources required by an interface for presenting the chat information may be reduced, and an interface switching speed may be improved.

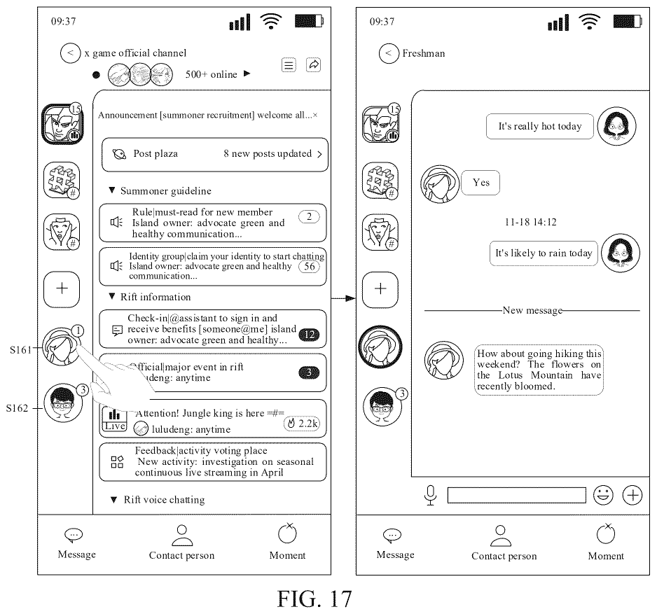

FIG. 17 is a schematic diagram showing a presentation manner of chat information of a target IM node according to an embodiment of this application. The left interface in FIG. 17 represents that the target object selects a first IM node S161 from two current IM nodes S161 and S162 as the target IM node. For example, the target object may quickly click an avatar of the target IM node, and the left interface in FIG. 17 is switched to the right interface. A panel (i.e., the community framework area) of the right interface displays a latest chat dialog of the target IM node in a chat window manner for the target object to view. As shown in the right interface in FIG. 17, the sub-communities displayed in the original community framework area are directly switched to the chat information of the target IM node.

In this manner, the target object may click an input box to process a corresponding message, thereby ensuring the efficiency of IM. An implementation is as follows.

A message input box is presented while presenting the chat information of the target IM node. When the target object clicks the input box, the client evokes a virtual keyboard in response to a trigger operation for the message input box. Then, the target object may input and publish a new message through the virtual keyboard, and the client displays, in response to new message inputting and publishing operations triggered through the virtual keyboard, the published new message in the chat information.

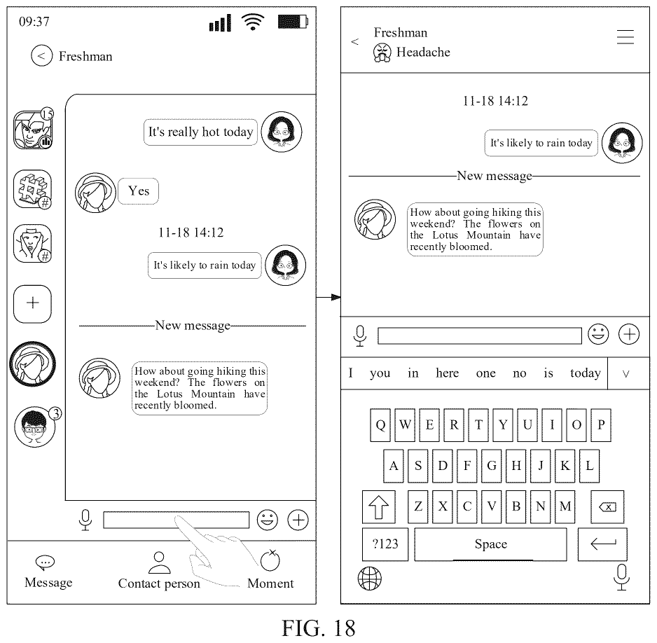

FIG. 18 is a schematic diagram showing a process for evoking a virtual keyboard according to an embodiment of this application. The left interface in FIG. 18 represents a process of evoking the virtual keyboard in a case that the target object clicks the message input box. After evoking the virtual keyboard, the target object may further input a new message that the target object wants to publish and publish the new message through the virtual keyboard. In a case that the target object publishes a new message, the new message may be presented in a chat area (not shown in FIG. 18) above the message input box.

Specifically, in the evoking process, the message interaction interface in the target form may be switched to a chat interface corresponding to the target IM node, as an interface shown in the right side of FIG. 18. In addition, the target object may further click a return button “<” at an upper left corner of the chat interface to return to the message interaction interface in the target form.

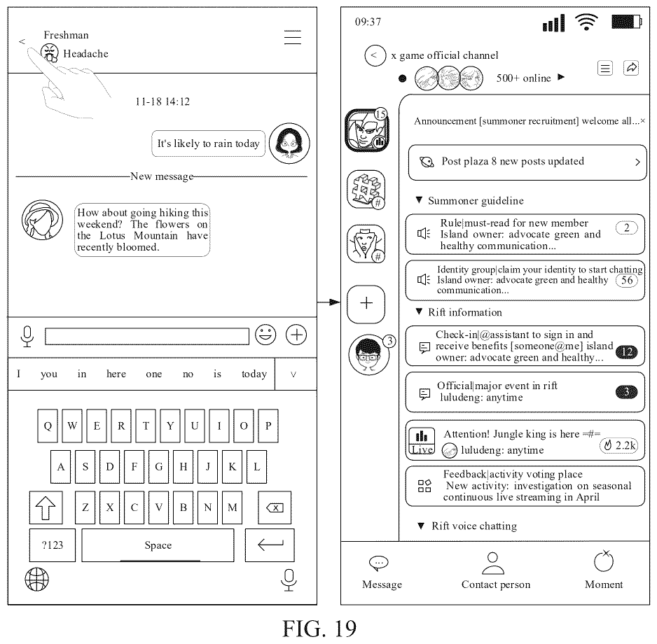

FIG. 19 is a schematic diagram showing a process for returning to a message interaction interface according to an embodiment of this application. FIG. 19 represents a process of returning from a chat interface to the message interaction interface after the target object clicks a return button “<” at an upper left corner of the chat interface.

Specifically, in response to a return operation triggered after the chat information is viewed, the client may switch from the chat interface back to the message interaction interface in the target form and cancel displaying of the temporary node identification of the target IM node in the message node identification area of the message interaction interface in the target form, i.e., no longer displaying the temporary node identification of the target IM node.

As shown in the right side of FIG. 19, only a temporary node identification of another IM node (corresponding to S162 shown in FIG. 18) that has not been viewed is displayed in a message node identification area of the interface.

Manner 2: a chat sub-interface corresponding to the target IM node is presented in the message interaction interface in the target form, and the chat information of the target IM node is displayed in the chat sub-interface.

This manner represents that mini AIO (which may be in a form of a floating layer, a pop-up window, a floating window, or the like) corresponding to the target IM node is presented in the current message interaction interface in the target form.

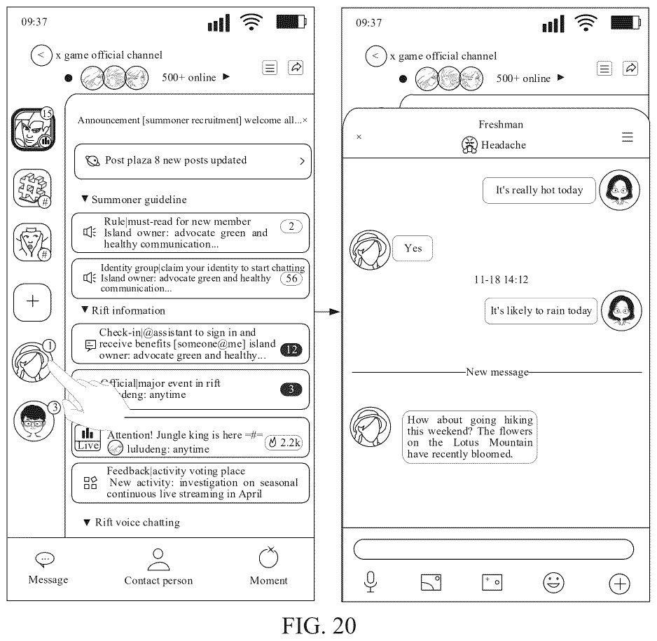

FIG. 20 is a schematic diagram showing another presentation manner of chat information of a target IM node according to an embodiment of this application. FIG. 20 uses the mini AIO in the form of a floating layer as an example. Referring to the left interface in FIG. 20, the target object selects the first one from two current IM nodes as the target IM node. For example, the target object may quickly click an avatar of the target IM node, that is, a floating layer shown in the right interface in FIG. 20 may be presented in the message interaction interface, and a latest chat dialog of the target IM node is displayed in the floating layer for the target object to view.

In this manner, the target object may further click an input box to process a corresponding message, thereby ensuring the efficiency of IM. An implementation is as follows.

A message input box is presented while presenting the chat information of the target IM node. When the target object clicks the input box, the client evokes a virtual keyboard in response to a trigger operation for the message input box. Then, the target object may input and publish a new message through the virtual keyboard, and the client displays, in response to new message inputting and publishing operations triggered through the virtual keyboard, the published new message in the chat information.

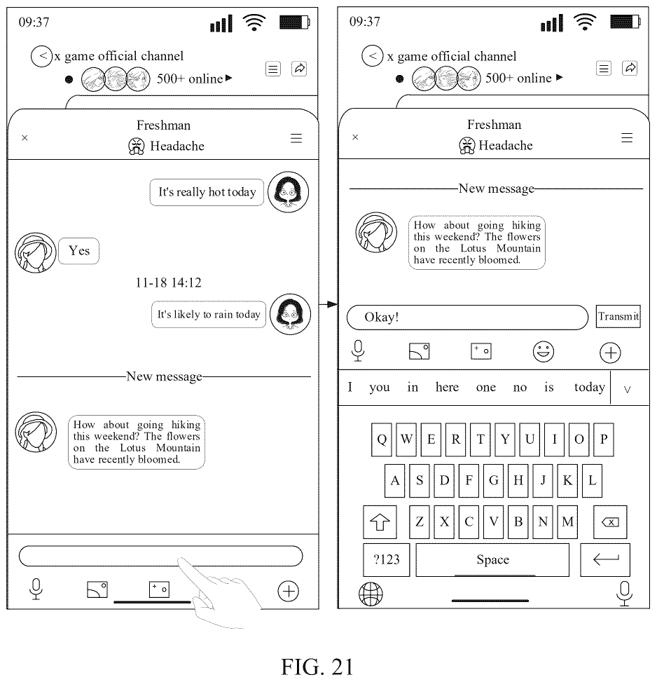

FIG. 21 is a schematic diagram showing another process for evoking a virtual keyboard according to an embodiment of this application. FIG. 21 represents a process of evoking the virtual keyboard in a case that the target object clicks the message input box. After evoking the virtual keyboard, the target object may further input a new message that the target object wants to publish and publish the new message through the virtual keyboard. As shown in the right interface in FIG. 21, the target object currently inputs “OK!.” Subsequently, the target object may click a “transmit” button to publish a new message. In a case that the target object publishes a new message, the new message may be presented in a chat area (not shown in FIG. 21) above the message input box.

The target object may further click a close button “x” at an upper left corner of the chat interface to close the floating layer, so as to return to the message interaction interface in the target form. In this case, the target IM node that has been clicked to view disappears.

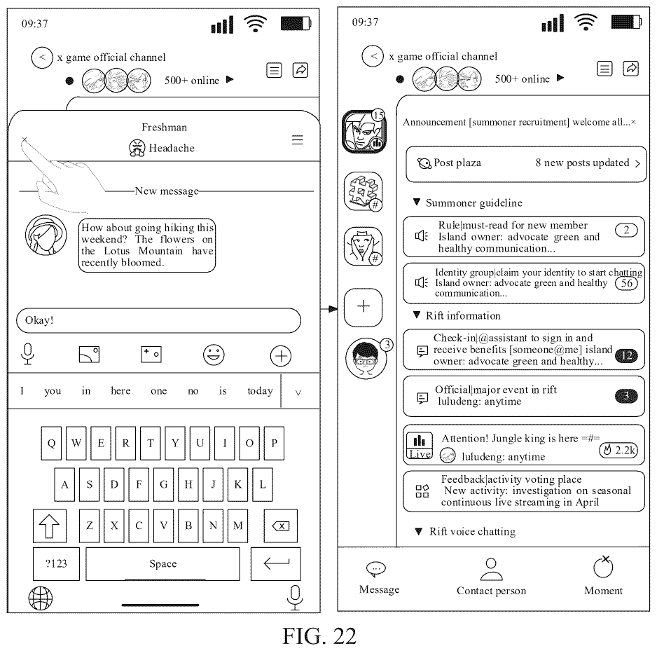

FIG. 22 is a schematic diagram showing another process for returning to a message interaction interface according to an embodiment of this application. FIG. 22 represents a process of closing a chat sub-interface to return to the message interaction interface when the chat sub-interface corresponding to the target IM node (corresponding to S162 shown in FIG. 18) is presented in the message interaction interface in the target form.

Specifically, in response to a return operation triggered after the chat information is viewed, the client closes the chat sub-interface to return to the message interaction interface in the target form and cancels displaying of the temporary node identification of the target IM node in the message node identification area of the message interaction interface in the target form, i.e., no longer displaying the temporary node identification of the target IM node. As shown in the right side of FIG. 22, only a temporary node identification of another IM node (corresponding to S162 shown in FIG. 18) that has not been viewed is displayed in a message node identification area of the interface.

An example in which the target IM node is a C2C node is used in the foregoing, and the same manner is used when the target IM node is a group chat node. This is not specifically limited herein.

In addition, some trigger operations, selection operations, and the like in this specification are exemplified by clicking. In addition, other operations such as double-clicking and long-pressing may further be used. This is not specifically limited herein.

In the foregoing implementation, when a message list sidebar form is currently presented on the display screen, if a new IM message is generated, a C2C avatar, a group chat avatar, and a message red dot may additionally appear in the sidebar. The object may quickly click the avatar to present a latest chat dialog in a chat window manner for the object to view. The object may click an input box in the chat window to process a corresponding message, thereby ensuring the efficiency of IM.

The community message interaction method in the embodiments of this application is mainly described from the perspective of interface presentation. The community message interaction method in the embodiments of this application is further described below from the perspective of technologies.

Since the message list in the message interaction interface in this embodiment of this application may not only present the IM node, but also present the community node, related improvements need to be made in the technical sections of subscribing to a community node by the object, transmitting a message, and refreshing the message list after operating a community function. The related improvements are generally as follows.

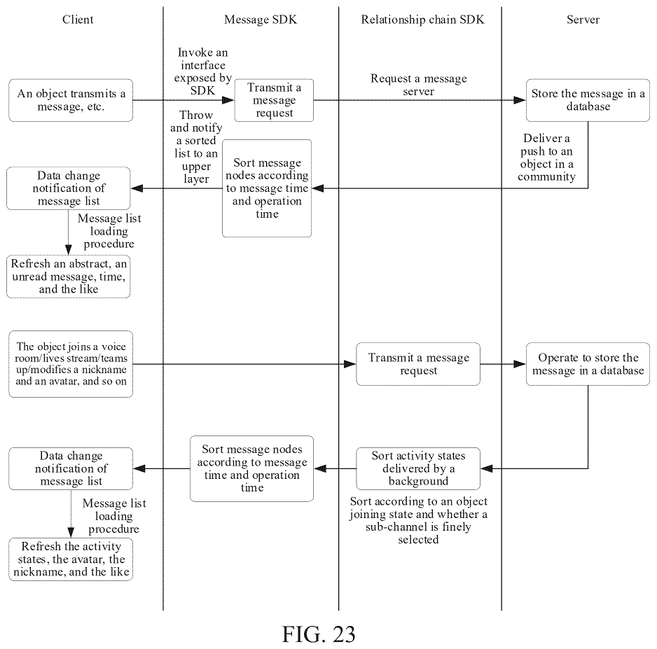

First, a message transmitting procedure is started to be described. After the object subscribes to a community node in a community tab or channel setting to the message list, subsequent updating of community nodes in the message list has a relationship with a message change in a community and an operation of the object. A general procedure is shown in FIG. 23.

FIG. 23 is a schematic diagram showing a message transmitting procedure according to an embodiment of this application. The figure briefly describes a message transmitting interaction procedure among a client, a message software development kit (SDK), a relationship chain SDK, and a server. The message SDK and the relationship chain SDK are cross-platform SDKs and support clients such as Android, iOS, and a personal computer (PC). An iOS system is mainly used as an example in this specification, and other systems are also applicable. Details are not described herein again.

From a technical perspective, in a transition process of two forms, from a data source level, two sets of data logics (sorting, frequency limiting, and the like) need to be maintained, and a new set of rules needs to be integrated to be compatible with data presentation rules in different forms. Specifically, according to different updated content, the presentation rule may be divided into the following two parts.
1. When the object transmits a message or the like through a client, the client invokes an interface exposed by the message SDK to transmit a message request to the server. Further, the server stores the message in a database and delivers a push message to an object in an associated community. The message SDK sorts the message nodes according to the message time and the operation time and throws and notifies a sorted message list to an upper-layer application. The client receives a data change notification of the message list and then performs a message list loading procedure to refresh an abstract, an unread message, time, and the like.
2. The object may further join a voice room/live stream/team up/modify a nickname and an avatar, and so on through the client. In this case, the client transmits a message request to the server through the relationship chain SDK. Further, the server stores the message in the database, and sorts, through the relationship chain SDK, activity states delivered by the background (sorting is performed according to an object joining state and whether a sub-channel is finely selected, and details may refer to a process of determining a priority in the foregoing embodiment and are not described again). Further, the message SDK sorts the message nodes according to the message time and the operation time and throws and notifies a sorted message list to an upper-layer application. The client receives the data change notification of the message list and then performs the message list loading procedure to refresh activity states, an avatar, a nickname, and the like.

The foregoing two parts both relate to the message list loading procedure. The message list loading procedure in this embodiment of this application is briefly described below.

The “message list loading procedure” part in FIG. 23 refers to that: after the client receives a data change notification of the message list, the client incrementally updates the data in a sub-thread, finds out a node to be added, deleted, or modified among all message nodes, and performs incremental refresh on the message list to avoid full update of the list, which may interrupt animations and result in poor performance. An implementation is as follows.

The client receives a data change notification for the message interaction interface, finds out a target message node that needs to perform a data update among the message nodes according to the data change notification through a sub-thread, and incrementally updates current display data of the target message node in the message interaction interface through a main thread after it is determined that a refresh opportunity is reached. For example, the message nodes are a plurality of message nodes associated with the target object displayed in the message interaction interface.

That is, the client may determine, through the sub-thread, a target message node that needs to be incrementally updated, and incrementally update the message interaction interface when refreshing is needed according to a frequency limiting logic.

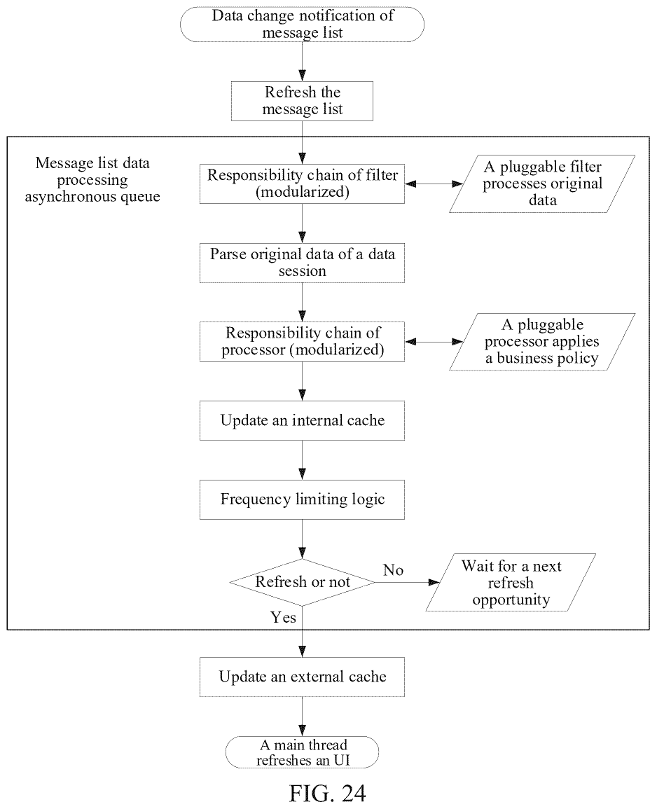

FIG. 24 is a schematic diagram showing a message list loading procedure according to an embodiment of this application. When receiving the data change notification of the message list, the client needs to refresh the message list, and a specific processing process is as follows.

The rectangular-box message list data processing asynchronous queue part is a process of sub-thread processing in this application. The process further relates to a filter and a processor. The filter in this embodiment of this application is a pluggable filter configured to process original data. Correspondingly, a responsibility chain of the filter is modularized, for example, according to message types, and messages of different types are processed by different filter modules.

Similarly, the processor in this embodiment of this application is a pluggable processor applying a business policy. Correspondingly, a responsibility chain of the processor is further modularized. For example, modules are divided according to message types, and messages of different types are processed by different processor modules.

Referring to the flowchart shown in FIG. 24, an implementation for determining a target message node that needs to be incrementally updated is as follows.

First, data that does not need to be notified in the data change notification is filtered out through a filter in the sub-thread.

In this embodiment of this application, the filter is configured to filter original message data to remove message data that does not need to be presented (i.e., does not need to be prompted), such as group assistant message data.

Then, after the remaining data is parsed, a parsing result is compared with current display data of the message interaction interface through the processor in the sub-thread to determine a target message interface. The target message interface may be determined according to updated information of the message nodes.

In this embodiment of this application, original data of a data session is parsed so that the data structure of the original data remaining after the filtering is converted and parsed into a structure that may be processed by the client, as the parsing result. After parsing, the parsing result may be compared with message data in a message list in an existing message interaction interface through the filter to determine which message data needs to be updated (added, deleted, or modified), for example, changing the number and positions of messages, adding a new message, and deleting an old message.

Finally, cached data related to the target message node in the sub-thread is updated based on a comparison result.

In this embodiment of this application, after comparison by the processor, the internal cache of the sub-thread may be incrementally updated.

When the current display data of the target message node is incrementally updated, an implementation is as follows.

Cached data related to the target message node in the main thread is updated. Further, the current display data of the target message node is incrementally updated in the message interaction interface based on the cached data.

Before the foregoing update process is performed, whether to refresh the message interaction interface further needs to be analyzed according to a frequency limiting logic, and if yes, the external cache of the main thread is further updated, and the UI is refreshed (the message interaction interface is refreshed) through the main thread. Otherwise, wait for a next refresh opportunity.

The foregoing describes the message transmitting procedure and the message list loading procedure in the embodiments of this application, and the following briefly describes a hierarchical structure of the message interaction interface and related animations in the embodiments of this application.

The message interaction interface in this embodiment of this application may be divided into a plurality of modules according to business logic to form a message list hierarchical structure.

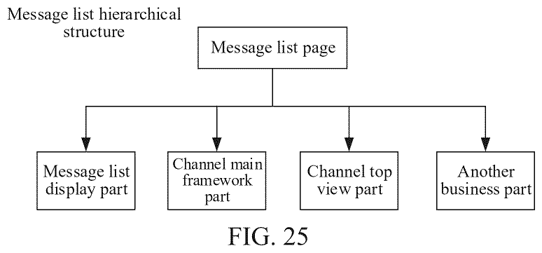

FIG. 25 is a schematic diagram showing a message list hierarchical structure according to an embodiment of this application. The message interaction interface shown in FIG. 25 may be divided into several modules as follows: a message list display part, a channel main framework part, a channel top view part, and another business part.

The division of the hierarchical structure listed in FIG. 25 corresponds to the layout of the message interaction interface listed in FIG. 10. That is, the message node identification area corresponds to the message list display part, the community framework area corresponds to the channel main framework part, and the title area corresponds to the channel top view part.

The part framework is a self-studied framework of decoupling VC service logics in this application and provides a plurality of communication manners between service logics to avoid bloated and unmaintainable VC logics. An expanded form after the community node is clicked may refer to FIG. 10. These areas contain a large amount of business logic when entering the expanded form and exiting the expanded form, and then part decoupling may be performed according to the foregoing hierarchical structure diagram. Two parts mentioned in a subsequent animation distribution framework are generated in this way.

The message interaction interface in this embodiment of this application has two forms: an initial form and a target form. From the UI level, in a transition process between forms, fine processing needs to be performed on moving positions and changing forms of a plurality of existing elements (including the avatar, the message abstract, and the like) to achieve a natural transition connecting effect, so as to ensure correct reading and presentation of information and a state in a scene in which the message list is refreshed at a high frequency. The transition connecting effect listed above may be realized through the form switching animation in the embodiments of this application.

The implementation of the form switching animation of the message interaction interface in this embodiment of this application is briefly described below still through the area distribution shown in FIG. 10 as an example.
(1) A message list avatar area (i.e., the message node identification area S102) is not displaced, but is animated to zoom in and zoom out. A text area is animated to move left/right.

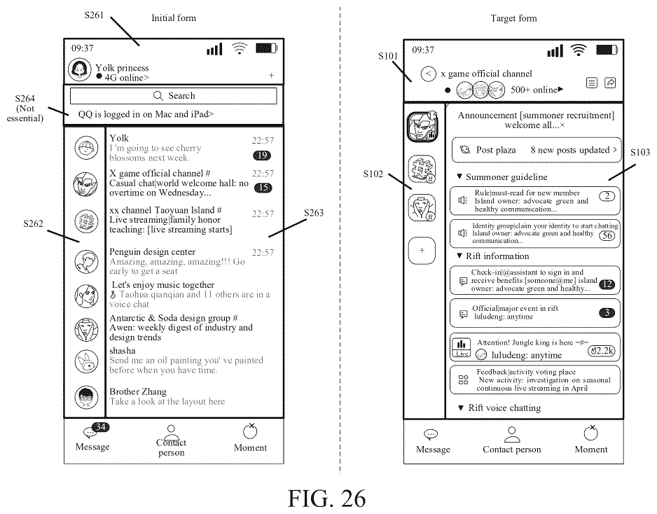

The text area refers to a message prompt information part in the message interaction interface in the initial form, for example, the area S263 in FIG. 26.
(2) A channel framework area (i.e., the community framework area S103) is animated to move left/right.
(3) A title area (i.e., the title area S101) and a navigation bar fade out and fade in, and a left avatar area of the navigation bar is animated to move left/right.

The navigation bar refers to an upper part of the message interaction interface in the initial form, for example, an area S261 in FIG. 26. The left avatar area of the navigation bar refers to an avatar area in S261.

FIG. 26 is a schematic diagram showing message interaction interfaces in an initial form and a target form according to an embodiment of this application.

The zoom-in and zoom-out animation refers to zooming in or zooming out of the node avatar in different interface presentation modes. If the size of the avatar in an ordinary mode is 48×48 pixels, and the size of the avatar in a simple mode is 52×52 pixels, switching from the ordinary mode to the simple mode needs zooming in processing; otherwise, switching from the simple mode to the ordinary mode needs zooming out processing.

Animating the text area S263 to move left/right refers to that form switching of the message interaction interface may be triggered by gesture sliding. For example, when sliding left, the initial form is switched to the target form, and when sliding right, the target form is switched to the initial form. In this manner, in the left sliding process, the text area S263 may move leftwards to gradually move out of a current interface of a display screen, and meanwhile, the channel framework area S103 also moves leftwards to gradually move to the current interface of the display screen, until the text area is entirely moved out and the channel framework area is entirely moved in. In addition, the displaying and sorting of the avatars in the message list avatar area (corresponding to S262 and S102) are adaptively updated, and the initial form is switched to the target form. On the contrary, in the right sliding process, the channel framework area S103 may move rightwards to gradually move out of the current interface of the display screen, and meanwhile, the text area S263 also moves rightwards to gradually move to the current interface of the display screen, until the channel framework area is entirely moved out and the text area is entirely moved in, and the target form is switched to the initial form.

In the foregoing implementation, the logic of the message list may be reused without recreating an avatar list and additionally processing logic such as message sorting and updating, thereby saving computing resources.

In addition, heights of the channel framework area and the title area are specific. In the initial form, a network, a logged-in small horizontal bar, a search box, and the like may also appear above the message list, as shown in a part S264 in FIG. 26. In the expanded form, the network, logged-in small horizontal bar, search box, and the like do not need to be displayed. Therefore, when the form switching animation related to the initial form and the expanded form is made, some special processing needs to be performed. An implementation is as follows.
1. When there is a small horizontal bar above the message list in the initial form, a channel is opened/collapsed, and the message list needs to be animated to move up/down. This may be realized by modifying a content offset contentOffset of a table view control (tableView).

The contentOffset is an offset of a vertex of a current display area of a scrollview relative to a vertex of a frame, where contentOffset.y=a difference between the top of the content and the top of the frame, and contentOffset.x=a difference between the left of the content and the left of the frame.

When the contentOffset is set, in this application, it is considered that an animation duration and an animation curve cannot be controlled by directly setting the animation through setContentOffset (contentOffset: CGPoint, animated: Bool). Therefore, in this application, a curve effect of linked animations is aligned through the time buffer function created according to the control points (0.38, 0.7) and (0.125, 1.0), and the contentOffset is continuously adjusted through the callback of the CADisplayLink timer.
2. After the animation ends, the small horizontal bar, the search box, and the like need to be processed.

If a channel is opened (including when the gesture stops), the search box and the small horizontal bar need to be removed, logic of pulling down to appear a mini program is processed, and contentInset of the tableView is adjusted. In this way, in the channel expanded form, redundant UI layouts at the top of the message cannot be seen when pulling down the avatar list.

The contentInset is a position of a vertex of a content view (contentview) of the scrollview relative to the scrollview, i.e., an inner edge, and contentInset=a distance (adhered to the content) increased around the content.

If the channel is collapsed (including when the gesture starts), the search box and the small horizontal bar need to be displayed first, and contentInset and contentOffset of the tableView are adjusted.

In this embodiment of this application, the search box may realize display hiding by setting a table header view attribute (tableHeaderView) of the tableView, and the small horizontal bar may realize display hiding by performing table view reloading (tableView reloadSections) after a data source is removed.

The animation distribution framework in this embodiment of this application is briefly described below.

According to the message list hierarchical structure shown in FIG. 25, in addition to the message list display part (NTMsgListviewPart), two parts are further added in this application. The two parts are as follows.
1. Channel main framework part (NTMsgListGuildPart).

The part is configured for processing logic related to the channel main framework, and complies with an animation protocol NTMsgListGuildAnimationProtocol to realize animation state monitoring.
2. Channel top view part (NTMsgListGuildHeaderPart).

The part is configured for processing logic related to a top view (for example, an area S101-title area) of the channel main framework, and complies with the animation protocol NTMsgListGuildAnimationProtocol to realize animation state monitoring.

In this embodiment of this application, the message list display part (NTMsgListViewPart) complies with the animation protocol NTMsgListGuildAnimationProtocol to realize animation state monitoring. The animation control class NTMsgListGuildAnimationControl uniformly manages animation distribution in an animation expansion and collapsing process. An animation class NTContainerLayoutTransition is an enumeration, contains immediate execution and animation execution, and provides a series of extension methods of animations. A corresponding animation may be executed as long as View/Layer is introduced. This is highly decoupled.

The following briefly describes the animation control class NTMsgListGuildAnimationControl, the animation protocol NTMsgListGuildAnimationProtocol, and the animation class NTContainerLayoutTransition in this embodiment of this application.
1. The animation control class NTMsgListGuildAnimationControl includes the following several methods, which are respectively:
showGuild, hideGuild, and addAnimationSubscribers.

showGuild (animated: Bool) is a community expansion method, i.e., a method that needs to be invoked when the initial form is switched to the target form, and hideGuild (animated: Bool) is a community collapsing method, i.e., a method that needs to be invoked when the target form is switched to the initial form. addAnimationSubscribers (_subscribers: [NTMsgListGuildAnimationProtocol]) represents a method for adding a subscriber, and may be configured for representing which subscriber parts are involved in the subscription of form switching animations such as community expansion and community collapsing.
2. The animation protocol NTMsgListGuildAnimationProtocol is configured for defining the following content:
onLayoutUpdated (transition: ContainerLayoutTransition, transitionFraction: CGFloat), representing the distribution of animation-related parameters, such as an animation duration, an animation type, and animation progress.
3. An animation class NTContainerLayoutTransition (enum) includes the following two execution methods:
case immedlate, representing immediate execution; and
case animated (duration: Double, curve: ContainerLayoutTransitionCurve), representing animation execution.

The animation class NTContainerLayoutTransition (enum) further includes, but is not limited to, the following animation curves:
case linear, case easeInout, case spring . . .

The foregoing is merely a brief description of technologies related to animations in the embodiments of this application and is not limited herein.

The animation distribution procedures in the embodiments of this application are briefly described below.

In this embodiment of this application, animation parameters include but are not limited to: an animation duration, an animation type, animation progress, and the like. The construction and distribution of the animation parameters are realized through the animation control class NTMsgListGuildAnimationControl and need to be subscribed to by a part that monitors an animation state.

In this embodiment of this application, the object may click a channel node (i.e., the community node, which may be an avatar of the community node) or perform gesture sliding so that the channel is animated to be expanded, and the message list is switched from the initial form to the message list sidebar form.

In addition, in the message list sidebar form, the object may further quickly return to the initial form of the message list by returning to or clicking a bottom navigation icon, clicking a channel node, or gesture sliding, and the channel is animated to be collapsed to view all IM messages.

In the foregoing form switching process, a form switching animation is accompanied. For example, when the initial form is switched to the message list sidebar form, some areas may move left/right, and some areas may fade out/fade in. Details may refer to the foregoing embodiment and are not described again.

An implementation is as follows. Form switching is performed on the message interaction interface in the following manner.

In response to a target operation triggered for the message interaction interface, a corresponding first animation parameter, specifically including an animation duration, an animation type, animation progress, and the like, is constructed by invoking a related method of a preset animation control class. Further, the animation parameter is distributed to corresponding subscriber modules (i.e., subscriber parts) to execute a form switching animation represented by the animation parameter through the subscriber modules and perform form switching on the message interaction interface.

The target operation includes, but is not limited to, clicking a community node expansion channel (as shown in FIG. 6A and FIG. 6B), clicking a return to collapse channel, clicking a community node collapsing channel, and the like.

In some embodiments, before constructing the corresponding animation parameter by invoking the related method of the preset animation control class, the target operation may be responded to by calling back a content selection method of a view data class corresponding to the target community node.

In this embodiment of this application, whether the content selection method of the view data class corresponding to the target community node needs to be called back is related to a type of the target operation. In a case that the community node is clicked, this operation needs to be performed, and in a case that the return is clicked, this operation does not need to be performed.

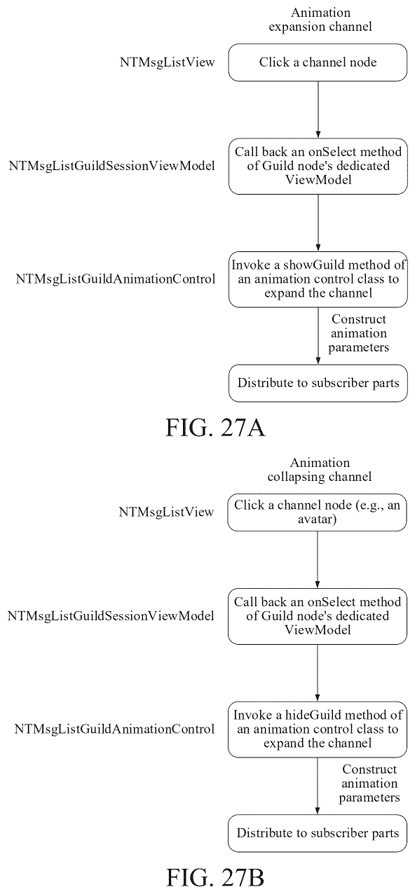

FIG. 27A to FIG. 27C are schematic diagrams of several animation distribution procedures shown in this application.

FIG. 27A is a schematic diagram showing a first animation distribution procedure according to an embodiment of this application. The schematic diagram represents a distribution procedure of a related animation in which the message interaction interface is switched from the initial form to the target form in a case that the object triggers an animation expansion channel by clicking a channel node. The message list display part (NTMsgListviewPart) monitors an operation of clicking a channel node, responds to the operation by calling back an onSelect method (i.e., the content selection method of the view data class corresponding to the target community node) of the Guild node's dedicated ViewModel, further constructs a corresponding first animation parameter by invoking a showGuild method of a preset animation control class NTMsgListGuildAnimationControl, and distributes the first animation parameter to the subscriber modules (i.e., subscriber parts) related to channel expansion, such as parts corresponding to several areas listed in FIG. 25. Further, these subscriber modules perform a related animation to realize channel expansion and switching from the initial form to the target form.

FIG. 27B is a schematic diagram showing a second animation distribution procedure according to an embodiment of this application. The schematic diagram represents a distribution procedure of a related animation in which the message interaction interface is switched from the target form to the initial form in a case that the object triggers an animation collapsing channel by clicking a channel node. Similar to FIG. 27A, the message list display part (NTMsgListviewPart) monitors an operation of clicking a channel node, responds to the operation by calling back an onSelect method (i.e., the content selection method of the view data class corresponding to the target community node) of the Guild node's dedicated ViewModel, further constructs a corresponding first animation parameter by invoking a hideGuild method of a preset animation control class NTMsgListGuildAnimationControl, and distributes the first animation parameter to the subscriber modules (i.e., subscriber parts) related to channel expansion, such as parts corresponding to several areas listed in FIG. 25. Further, these subscriber modules perform a related animation to realize channel collapsing and switching from the target form to the initial form.

As further shown in FIG. 27C, FIG. 27C is a schematic diagram showing a third animation distribution procedure according to an embodiment of this application. The schematic diagram represents a distribution procedure of a related animation in which the message interaction interface is switched from the target form to the initial form in a case that the object triggers an animation collapsing channel by clicking the return. Different from FIG. 27B, in this manner, the content selection method of the view data class corresponding to the target community node does not need to be invoked, but a hideGuild method of a preset animation control class NTMsgListGuildAnimationControl is directly invoked to construct a corresponding first animation parameter. Details are not described herein again.

In addition, in this embodiment of this application, the object may further trigger a message prompt by gesture sliding.

In response to a specified gesture triggered for the message interaction interface, a corresponding second animation parameter is constructed in real time based on the specified gesture. Then, the second animation parameter is distributed to a corresponding subscriber module to execute a form switching animation represented by the animation parameter through the subscriber module and perform form switching on the message interaction interface.

FIG. 27D is a schematic diagram showing a fourth animation distribution procedure according to an embodiment of this application. In a case that the gesture slides left/right, a related animation parameter is constructed in real time according to the progress of the gesture and distributed to subscriber modules (i.e., subscriber parts) related to channel expansion/collapsing, such as, parts corresponding to several areas listed in FIG. 25. Further, these subscriber modules execute a related animation to switch interface forms.

The community message interaction method provided in this application breaks inconvenience caused by a plurality of hierarchies in a community structure framework, efficiently helps an object to complete demands of IM and community chatting in a client social ecology, and saves computing resources and network resources. In addition, the dual form of the message list in this application is more convenient for an object to access chatting content and activities that the object is interested in. Further, in this application, from the perspective of an overall social ecology of a client, social links of the object may be better integrated so that the object may seamlessly join in different social experiences, thereby further improving the message interaction efficiency.

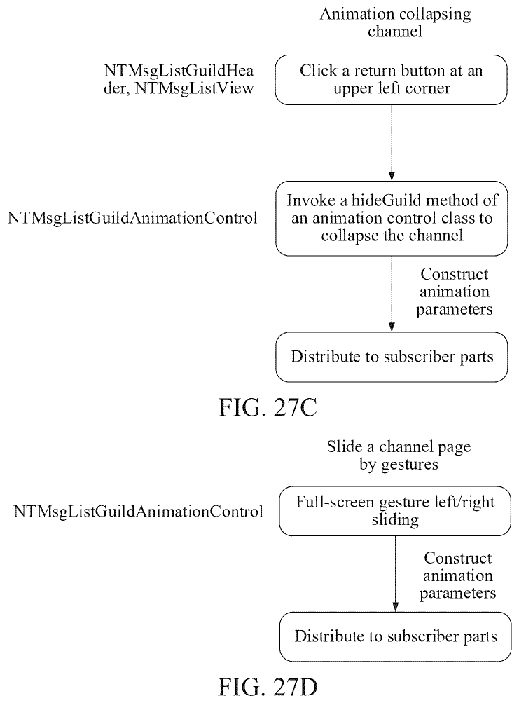

Based on the same inventive concept, the embodiments of this application further provide a community message interaction apparatus. FIG. 28 is a schematic structural diagram of a community message interaction apparatus 2800. The community message interaction apparatus 2800 may include:
a first display unit 2801 configured to present a message interaction interface in an initial form, the message interaction interface displaying a plurality of message nodes associated with a target object, and the plurality of message nodes including one or more community nodes and one or more IM nodes; and
a second display unit 2802 configured to switch, in response to a selection operation for a target community node of the one or more community nodes, the message interaction interface from the initial form to a target form in which at least one community node associated with the target object is determined by screening, the target form displaying a node identification of the at least one community node and at least one sub-community contained in the target community node, and the at least one community node including the target community node.

In some embodiments, in the initial form, when a community node in the one or more community nodes has one or more first real-time activities, first message prompt information of the community node is displayed on the message interaction interface, and the first message prompt information includes: an ongoing state identification corresponding to a first real-time activity whose priority among the one or more first real-time activities is in a first specified level; or

in the target form, when a community node in the at least one community node has one or more second real-time activities, an ongoing state identification corresponding to a second real-time activity whose priority among the one or more second real-time activities is in a second specified level is displayed at a related position of a node identification of the community node on the message interaction interface.

In some embodiments, the apparatus further includes:
a first response unit 2803 configured to jump, in response to a selection operation for a first sub-community of the at least one sub-community, from the message interaction interface to a chat interface of the first sub-community.

In some embodiments, when a new message is generated in sub-communities of a community node in the one or more community nodes, second message prompt information of the community node is displayed on the message interaction interface, and the second message prompt information includes: title information, presented in a text link style supporting interface jumping, of the sub-communities that generate the new message; and the apparatus further includes:
a second response unit 2804 configured to jump, in response to a trigger operation for title information of a second sub-community of the sub-communities that generate the new message, from the message interaction interface to a chat interface of the second sub-community.

In some embodiments, the apparatus further includes:
a third response unit 2805 configured to return to the message interaction interface in the initial form in response to a return operation triggered through the chat interface of the second sub-community, and switch the title information of the second sub-community from the text link style to an abstract style that does not support jumping.

In some embodiments, the message interaction interface in the target form includes a first area, a second area, and a third area; and the second display unit 2802 is specifically configured to:
display title information of the target community node in the first area, display the node identification of the at least one community node in the second area, and display the at least one sub-community contained in the target community node in the third area.

In some embodiments, when a new message is generated by at least one IM node, the apparatus further includes:
a third display unit 2806 configured to present, in the second area, a temporary node identification of the at least one IM node that generates a new message; and
present, in response to a trigger operation for a temporary node identification of a target IM node in the at least one IM node, chat information of the target IM node.

In some embodiments, the third display unit 2806 is specifically configured to:
switch the third area from displaying the at least one sub-community to displaying the chat information of the target IM node; or
present a chat sub-interface corresponding to the target IM node in the message interaction interface in the target form, and display the chat information of the target IM node in the chat sub-interface.

In some embodiments, the third display unit 2806 is further configured to:
cancel, in the second area in response to a return operation triggered after the chat information is viewed, displaying of the temporary node identification of the target IM node.

In some embodiments, the third display unit 2806 is further configured to:
present a message input box;
evoke a virtual keyboard in response to a trigger operation for the message input box; and
display, in response to new message inputting and publishing operations triggered through the virtual keyboard, the published new message in the chat information.

In some embodiments, the second display unit 2802 is further configured to:
respond to a community switching operation triggered through a node identification in the second area to switch to a community node corresponding to the node identification, switch the first area to display title information of the switched community node, and switch the third area to present at least one sub-community contained in the switched community node; and
present, in response to a selection operation for a third sub-community of the at least one sub-community contained in the switched community node, a chat interface of the third sub-community.

In some embodiments, the second display unit 2802 is further configured to:
display the node identification of the switched community node through a preset zoom animation, where the preset zoom animation represents that the node identification of the switched community node is zoomed out from an original scale to a target scale and then zoomed in from the target scale to the original scale.

In some embodiments, the message interaction interface of the target form further includes a community discovery entrance; and the apparatus further includes:
a fourth response unit 2807 configured to switch to a community discovery interface in response to a trigger operation for the community discovery entrance, and present the node identification of the at least one community node and at least one recommended community in the community discovery interface; and
add, in response to a join operation for a target recommended community of the at least one recommended community, a node identification of a community node corresponding to the target recommended community in the community discovery interface.

In some embodiments, the message interaction interface in the target form and the community discovery interface each include a third area, and the third area in the message interaction interface is configured for displaying community framework areas of the sub-communities. The third area in the community discovery interface is configured for displaying the at least one recommended community.

The fourth response unit 2807 is specifically configured to:
control the message interaction interface in the target form to switch to the community discovery interface by executing a switching animation representing that the third area in the message interaction interface in the target form fades out and the third area in the community discovery interface fades in.

In some embodiments, the apparatus further includes:
a message update unit 2808 configured to receive a data change notification for the message interaction interface;
find out a target message node that needs to perform a data update among the plurality of message nodes according to the data change notification through a sub-thread; and
incrementally update current display data of the target message node in the message interaction interface through a main thread after it is determined that a refresh opportunity is reached.

In some embodiments, the message update unit 2808 is specifically configured to:
filter out data that does not need to be notified in the data change notification through a filter in the sub-thread;
parse remaining data, and then compare a parsing result with the current display data of the message interaction interface through a processor in the sub-thread to determine a target message interface; and
update cached data related to the target message node in the sub-thread based on a comparison result.

In some embodiments, the message update unit 2808 is specifically configured to:
update cached data related to the target message node in the main thread; and
incrementally update the current display data of the target message node in the message interaction interface based on the cached data.

In some embodiments, a hierarchical structure of the message interaction interface contains: a plurality of modules divided according to business logic; and the apparatus further includes:
a first animation distribution unit 2809 configured to perform form switching on the message interaction interface in the following manner:
constructing, in response to a target operation triggered for the message interaction interface, a corresponding first animation parameter by invoking a related method of a preset animation control class; and
distributing the animation parameter to a corresponding subscriber module to execute a form switching animation represented by the animation parameter through the subscriber module and perform form switching on the message interaction interface.

In some embodiments, the first animation distribution unit 2809 is further configured to:
respond to the target operation by calling back a content selection method of a view data class corresponding to the target community node before the constructing a corresponding first animation parameter by invoking a related method of a preset animation control class.

In some embodiments, a hierarchical structure of the message interaction interface contains: a plurality of modules divided according to business logic; and the apparatus further includes:
a second animation distribution unit 2810 configured to perform form switching on the message interaction interface in the following manner:
constructing, in response to a specified gesture triggered for the message interaction interface, a corresponding second animation parameter in real time based on the specified gesture; and
distributing the second animation parameter to a corresponding subscriber module to execute a form switching animation represented by the animation parameter through the subscriber module and perform form switching on the message interaction interface.

In this application, since message prompt information corresponding to the community node and the IM node may be displayed on the same message interaction interface simultaneously, different social entrances do not need to be set, and an object enters different social interfaces by selecting different social entrances, thereby effectively improving the viewing efficiency of social messages and saving computing resources and network resources. Further, the message interaction interface in this application has a dual form. When the object has a requirement for viewing a community message, the object may directly select the target community node in the message interaction interface so that the message interaction interface is switched from the initial form to the target form in which the community nodes associated with the target object are determined by screening, and node identifications of the community nodes and sub-communities contained in the target community node are displayed. In this manner, demands of IM and community chatting may be ensured simultaneously, and the object is convenient to access chatting content and activities that the object is interested in, thereby further improving the message interaction efficiency.

For ease of description, the above parts are divided into various modules (or units) according to their functions and described separately. Certainly, in the implementation of this application, the functions of various modules (or units) may be implemented in the same piece of or a plurality of pieces of software and/or hardware.

After the community message interaction method and apparatus in exemplary implementations of this application are described, an electronic device according to another exemplary implementation of this application is described below.

A person skilled in the art may understand that various aspects of this application may be implemented as systems, methods, or program products. Therefore, various aspects of this application may be specifically embodied in the following forms: hardware only implementations, software only implementations (including firmware, micro code, etc.), or implementations with a combination of software and hardware, which are collectively referred to as “circuit,” “module,” or “system” herein.

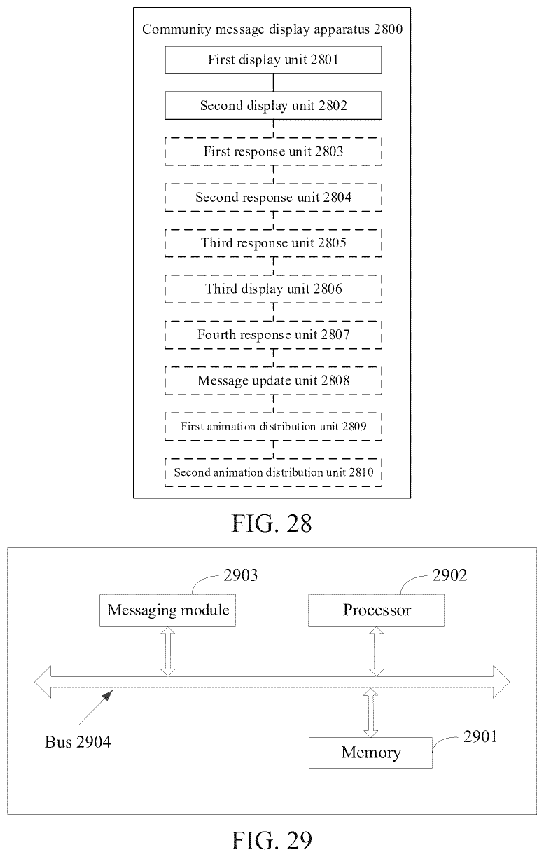

Based on the same inventive concept as the foregoing method embodiment, the embodiments of this application further provide an electronic device. In an embodiment, the electronic device may be a server, for example, the server 220 shown in FIG. 1. In this embodiment, the structure of the electronic device may be shown in FIG. 29, including a memory 2901, a messaging module 2903, and one or more processors 2902.

The memory 2901 is configured to store a computer program executed by the processor 2902. The memory 2901 may mainly include a program storage area and a data storage area. The program storage area may store an operating system, a program required for running an IM function, and the like. The data storage area may store various IM information, operation instruction sets, and the like.

The memory 2901 may be a volatile memory, such as a random-access memory (RAM). The memory 2901 may alternatively be a non-volatile memory, such as a read-only memory (ROM), a flash memory, a hard disk drive (HDD), or a solid-state drive (SSD). Alternatively, the memory 2901 is any other medium that can be configured to carry or store a desired computer program in a form of an instruction or a data structure and can be accessed by a computer, but is not limited thereto. The memory 2901 may be a combination of the foregoing memories.

The processor 2902 may include one or more central processing units (CPUs), a digital processing unit, or the like. The processor 2902 is configured to implement the foregoing community message interaction method when invoking a computer program stored in the memory 2901.

The messaging module 2903 is configured to communicate with a terminal device and other servers.

A specific connection medium among the foregoing memory 2901, messaging module 2903, and processor 2902 is not limited in this embodiment of this application. In this embodiment of this application, the memory 2901 and the processor 2902 are connected through a bus 2904 in FIG. 29. The bus 2904 is described through a thick line in FIG. 29. A connection manner among other assemblies is merely for exemplary description and is not intended to be limiting. The bus 2904 may be classified as an address bus, a data bus, a control bus, or the like. For ease of description, only one thick line is used for description in FIG. 29, but this does not imply that there is only one bus or one type of bus.

The memory 2901 includes a computer storage medium, and the computer storage medium has computer-executable instructions stored therein for implementing the community message interaction method of the embodiments of this application. The processor 2902 is configured to perform the foregoing community message interaction method, as shown in FIG. 2.

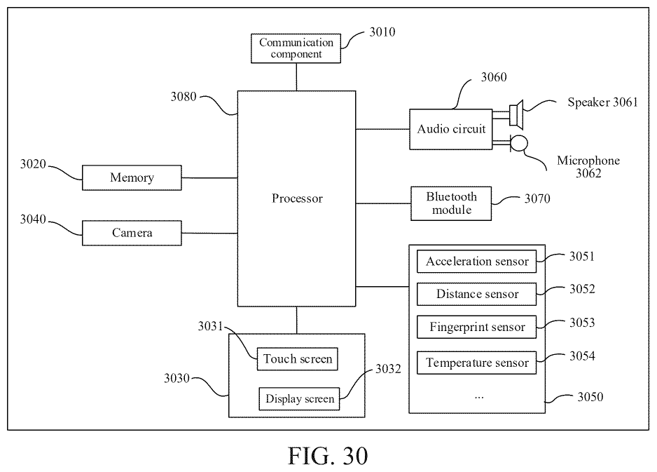

In another embodiment, the electronic device may alternatively be another electronic device, such as the terminal device 210 shown in FIG. 1. In this embodiment, the structure of the electronic device may be shown in FIG. 30, including: assemblies such as a communication component 3010, a memory 3020, a display unit 3030, a camera 3040, a sensor 3050, an audio circuit 3060, a Bluetooth module 3070, and a processor 3080.

The communication component 3010 is configured to communicate with a server. In some embodiments, a circuit wireless fidelity (WiFi) module may be included. The WiFi module belongs to a short-distance wireless transmission technology. The electronic device may help the user to receive and transmit information through the WiFi module.

The memory 3020 may be configured to store software programs and data. The processor 3080 executes various functions of the terminal device 210 and data processing by running software programs or data stored in the memory 3020. In addition, the memory 3020 may include a high-speed RAM and a non-volatile memory, such as at least one magnetic disk storage device, a flash memory device, or other volatile solid-state storage devices. The memory 3020 stores an operating system that enables the terminal device 210 to run. In this application, the memory 3020 may store an operating system and various application programs and may further store a computer program for performing the community message interaction method in the embodiments of this application.

The display unit 3030 may further be configured to display information inputted by the user, information provided to the user, and a graphical user interface (GUI) of various menus of the terminal device 210. Specifically, the display unit 3030 may include a display screen 3032 provided on a front surface of the terminal device 210. The display screen 3032 may be configured as a liquid crystal display, a light-emitting diode display, or the like. The display unit 3030 may be configured to display the message interaction interface, the chat interface, the community discovery interface, and the like in the embodiments of this application.

The display unit 3030 may further be configured to receive inputted numeric or character information, generate signal input related to user settings and function control of the terminal device 210. Specifically, the display unit 3030 may include a touch screen 3031 provided on the front surface of the terminal device 210 and may acquire touch operations of a user on or near the touch screen 3031, for example, clicking an icon or dragging a scroll box.

The touch screen 3031 may cover the display screen 3032, or the touch screen 3031 and the display screen 3032 may be integrated to implement input and output functions of the terminal device 210. The integrated screen may be referred to as a touch display screen. In this application, the display unit 3030 may display an application program and corresponding operations.

The camera 3040 may be configured to capture a static image, and the user may publish an image captured by the camera 3040 through an application. There may be one or more cameras 3040. An object generates an optical image through a lens, and the optical image is projected to a photosensitive element. The photosensitive element may be a charge coupled device (CCD) or a complementary metal-oxide-semiconductor (CMOS) phototransistor. The photosensitive element converts an optical signal into an electric signal, and then transfers the electric signal to the processor 3080 to convert into a digital image signal.

The terminal device may further include at least one sensor 3050, such as an acceleration sensor 3051, a distance sensor 3052, a fingerprint sensor 3053, and a temperature sensor 3054. The terminal device may further be configured with other sensors such as a gyroscope, a barometer, a hygrometer, a thermometer, an infrared sensor, an optical sensor, and a motion sensor.

The audio circuit 3060, a speaker 3061, and a microphone 3062 may provide audio interfaces between the user and the terminal device 210. The audio circuit 3060 may convert received audio data into an electric signal and transmit the electric signal to the speaker 3061. The speaker 3061 converts the electric signal into a sound signal and outputs the sound signal. The terminal device 210 may further be configured with a volume icon, configured to adjust the volume of the sound signal. In addition, the microphone 3062 converts an acquired sound signal into an electric signal. The electric signal is received by the audio circuit 3060 and converted into audio data, and then audio data is outputted to the communication component 3010 to be transmitted to another terminal device 210, or the audio data is outputted to the memory 3020 for further processing.

The Bluetooth module 3070 is configured to perform, through a Bluetooth protocol, information interaction with another Bluetooth device having a Bluetooth module. For example, the terminal device may establish, through the Bluetooth module 3070, a Bluetooth connection with a wearable electronic device (such as, a smartwatch) also having a Bluetooth module, so as to perform data interaction.

The processor 3080 is a control center of the terminal device and is connected to various parts of the entire terminal using various interfaces and lines. The processor 3080 executes various functions of the terminal device and performs data processing by running or executing a software program stored in the memory 3020 and invoking data stored in the memory 3020. In some embodiments, the processor 3080 may include one or more processing units. An application processor and a baseband processor may further be integrated into the processor 3080. The application processor mainly processes an operating system, an UI, an application program, and the like, and the baseband processor mainly processes wireless communication. In some embodiments, the foregoing baseband processor may be not integrated in the processor 3080. In this application, the processor 3080 may run an operating system, an application program, UI display, a touch response, and the community message interaction method in the embodiments of this application. In addition, the processor 3080 is coupled to the display unit 3030.

In some possible implementations, various aspects of the community message interaction method provided in this application may alternatively be implemented in the form of a program product including a computer program. When the program product runs on an electronic device, the computer program is configured to enable the electronic device to perform the operations in the community message interaction method described in this specification according to various exemplary implementations of this application. For example, the electronic device may perform the operations shown in FIG. 2.

The program product may be any combination of one or more readable mediums. The readable medium may be a readable signal medium or a readable storage medium. For example, the readable storage medium may be, but is not limited to, an electric, magnetic, optical, electromagnetic, infrared, or semi-conductive system, apparatus, or device, or any combination thereof. More specific examples (a non-exhaustive list) of the readable storage medium include: an electrical connection having one or more wires, a portable disk, a hard disk, a RAM, a ROM, an erasable programmable ROM (EPROM or a flash memory), an optical fiber, a portable compact disc ROM (CD-ROM), an optical storage device, a magnetic storage device, or any appropriate combination thereof.

The program product of the implementations of this application may adopt a portable CD-ROM and include a computer program, and may be run on the electronic device. However, the program product in this application is not limited thereto. In this specification, the readable storage medium may be any tangible medium containing or storing a program, and the program may be used by or used in combination with an instruction execution system, an apparatus, or a device.

The readable signal medium may include a data signal being in a baseband or propagated as a part of a carrier, in which a readable computer program is carried. A data signal propagated in such a way may adopt a plurality of forms, including, but not limited to, an electromagnetic signal, an optical signal, or any appropriate combination thereof. The readable signal medium may alternatively be any readable medium except the readable storage medium, and the readable medium may transmit, propagate, or transport a program used by or in combination with an instruction execution system, apparatus, or device.

The computer program included in the readable medium may be transmitted through any suitable medium, including but not limited to a wireless medium, a wire medium, an optical cable, a radio frequency (RF), etc., or any appropriate combination thereof.

The computer program for performing the operations of this application may be written through one or more programming languages or a combination thereof. The programming languages include an object-oriented programming language, such as Java and C++, and further include a conventional procedural programming language, such as “C” or similar programming languages. The computer program may be completely executed on a user electronic device, partially executed on a user electronic device, executed as an independent software package, partially executed on a user electronic device and partially executed on a remote electronic device, or completely executed on a remote electronic device or server. In a case involving the remote electronic device, the remote electronic device may be connected to the user electronic device through any type of network including a local area network (LAN) or a wide area network (WAN), or may be connected to an external electronic device (for example, through the Internet using an Internet service provider).

Although several units or sub-units of the apparatus have been mentioned in the detailed description above, such division is merely exemplary and not mandatory. Actually, according to the implementations of this application, the features and functions of two or more units described above may be specifically implemented in one unit. On the contrary, the features and functions of one unit described above may be further divided to be implemented by a plurality of units.

In addition, although the operations of the method in this application are described in a specific order in the accompanying drawings, this does not require or imply that these operations need to be performed in the specific order, or all described operations need to be performed to achieve the expected result. Additionally or alternatively, some operations may be omitted, a plurality of operations may be combined into one operation for execution, and/or one operation may be decomposed into a plurality of operations for execution.

A person skilled in the art would understand that the embodiments of this application may be provided as a method, a system, or a computer program product. Therefore, this application may use the forms of hardware-only embodiments, software-only embodiments, or embodiments combining software and hardware. Moreover, this application may use a form of a computer program product that is implemented on one or more computer-usable storage media (including but not limited to a disk memory, a CD-ROM, an optical memory, and the like) that contain a computer-usable computer program.

This application is described with reference to flowcharts and/or block diagrams of the method, the device (system), and the computer program product according to the embodiments of this application. Computer program instructions may implement each procedure and/or block in the flowcharts and/or block diagrams and a combination of procedures and/or blocks in the flowcharts and/or block diagrams. These computer program instructions may be provided to a general-purpose computer, a special-purpose computer, an embedded processor, or a processor of another programmable data processing device to generate a machine so that an apparatus configured to implement functions specified in one or more procedures in the flowcharts and/or one or more blocks in the block diagrams is generated through instructions executed by the computer or the processor of another programmable data processing device.

These computer program instructions may alternatively be stored in a computer-readable memory that can instruct a computer or another programmable data processing device to work in a specific manner so that the instructions stored in the computer-readable memory generate an artifact that includes an instruction apparatus. The instruction apparatus implements functions specified in one or more procedures in the flowcharts and/or one or more blocks in the block diagrams.

These computer program instructions may further be loaded onto a computer or another programmable data processing device so that a series of operations are performed on the computer or the another programmable device, thereby generating computer-implemented processing. Therefore, the instructions executed on the computer or the another programmable device provide operations for implementing functions specified in one or more procedures in the flowcharts and/or one or more blocks in the block diagrams.

Although exemplary embodiments of this application have been described, once a person skilled in the art know the basic creative concept, additional changes and modifications may be made to these embodiments. Therefore, the following claims are intended to be construed as to include the exemplary embodiments and all changes and modifications falling within the scope of this application.

What is claimed is:

1. A community message interaction method comprising:
presenting a message interaction interface in an initial form, the message interaction interface displaying a plurality of message nodes associated with a target object, and the plurality of message nodes including one or more community nodes and one or more instant messaging (IM) nodes; and
switching, in response to a selection operation for a target community node of the one or more community nodes, the message interaction interface from the initial form to a target form in which at least one screened community node associated with the target object is determined by screening, the target form displaying a node identification of the at least one screened community node and at least one sub-community contained in the target community node, and the at least one screened community node including the target community node.

2. The method according to claim 1, wherein:
in the initial form, in response to one community node of the one or more community nodes having one or more first real-time activities, first message prompt information of the one community node is displayed on the message interaction interface, the first message prompt information including an ongoing state identification corresponding to one of the one or more first real-time activities that has a priority of a first specified level; or
in the target form, in response to one screened community node of the at least one screened community node has one or more second real-time activities, an ongoing state identification corresponding to a second real-time activity whose priority among one of the one or more second real-time activities that has a priority of a second specified level is displayed at a related position of a node identification of the community node on the message interaction interface.

3. The method according to claim 1, further comprising:
jumping, in response to a selection operation for one sub-community of the at least one sub-community, from the message interaction interface to a chat interface of the one sub-community.

4. The method according to claim 1, further comprising:
displaying, in response to a new message being generated in a sub-community of one community node of the one or more community nodes, message prompt information of the one community node on the message interaction interface, the message prompt information including title information, presented in a text link style supporting interface jumping, of the sub-community; and
jumping, in response to a trigger operation for the title information, from the message interaction interface to a chat interface of the sub-community.

5. The method according to claim 4, further comprising, in response to a return operation triggered through the chat interface of the sub-community:
returning to the message interaction interface in the initial form; and
switching the title information of the sub-community from the text link style to an abstract style that does not support jumping.

6. The method according to claim 1, wherein:
the message interaction interface in the target form includes a first area, a second area, and a third area; and
displaying the node identification of the at least one screened community node and the at least one sub-community contained in the target community node includes:
displaying title information of the target community node in the first area;
displaying the node identification of the at least one screened community node in the second area; and
displaying the at least one sub-community contained in the target community node in the third area.

7. The method according to claim 6, further comprising, in response to a new message being generated by a target IM node associated with the target object:
presenting, in the second area, a temporary node identification of the target IM node; and
presenting, in response to a trigger operation for the temporary node identification, chat information of the target IM node.

8. The method according to claim 7, wherein presenting the chat information of the target IM node includes:
switching the third area from displaying the at least one sub-community to displaying the chat information of the target IM node; or
presenting a chat sub-interface corresponding to the target IM node in the message interaction interface in the target form, and displaying the chat information of the target IM node in the chat sub-interface.

9. The method according to claim 7, further comprising:
cancelling, in response to a return operation triggered after the chat information is viewed, displaying of the temporary node identification of the target IM node in the second area.

10. The method according to claim 7,
wherein presenting the chat information of the target IM node includes presenting a message input box;
the method further comprising:
evoking a virtual keyboard in response to a trigger operation for the message input box; and
displaying, in response to new message inputting and a publishing operation triggered through the virtual keyboard, published new message in the chat information.

11. The method according to claim 6, further comprising:
in response to a community switching operation triggered through one node identification in the second area, switching the first area to display title information of one community node corresponding to the one node identification, and switching the third area to present at least one sub-community contained in the one community node; and
presenting, in response to a selection operation for one sub-community of the at least one sub-community contained in the one community node, a chat interface of the one sub-community.

12. The method according to claim 11, further comprising, in response to the community switching operation:
displaying the one node identification of the one community node through a preset zoom animation, the preset zoom animation representing that the one node identification is zoomed out from an original scale to a target scale and then zoomed in from the target scale to the original scale.

13. The method according to claim 6, further comprising:
in response to a trigger operation for a community discovery entrance in the message interaction interface in the target form, switching to a community discovery interface and presenting the node identification of the at least one screened community node and at least one recommended community in the community discovery interface; and
adding, in response to a join operation for a target recommended community of the at least one recommended community, a node identification of a community node corresponding to the target recommended community in the community discovery interface.

14. The method according to claim 13, wherein:
the community discovery interface includes the third area, configured to display the at least one recommended community; and
switching to the community discovery interface includes:
controlling the message interaction interface in the target form to switch to the community discovery interface by executing a switching animation representing that the third area in the message interaction interface in the target form fades out and the third area in the community discovery interface fades in.

15. The method according to claim 1, further comprising:
receiving a data change notification for the message interaction interface;
finding out a target message node that needs a data update among the plurality of message nodes according to the data change notification through a sub-thread; and
incrementally updating current display data of the target message node in the message interaction interface through a main thread after determining that a refresh opportunity is reached.

16. The method according to claim 15, wherein finding out the target message node includes:
filtering out data that does not need to be notified in the data change notification through a filter in the sub-thread;
parsing remaining data to obtain a parsing result, and comparing the parsing result with the current display data of the message interaction interface through a processor in the sub-thread to determine a target message interface to obtain a comparison result; and
updating cached data related to the target message node in the sub-thread based on the comparison result.

17. The method according to claim 15, wherein incrementally the updating current display data of the target message node includes:
updating cached data related to the target message node in the main thread; and
incrementally updating the current display data of the target message node in the message interaction interface based on the cached data.

18. The method according to claim 1,
wherein a hierarchical structure of the message interaction interface contains a plurality of modules divided according to business logic;
the method further comprising:
performing form switching on the message interaction interface, including:
constructing, in response to a target operation triggered for the message interaction interface, an animation parameter by invoking a method of a preset animation control class; and
distributing the animation parameter to a subscriber module to execute a form switching animation represented by the animation parameter through the subscriber module and perform form switching on the message interaction interface.

19. The method according to claim 1,
wherein a hierarchical structure of the message interaction interface contains a plurality of modules divided according to business logic;
the method further comprising:
performing form switching on the message interaction interface, including:
constructing, in response to a gesture triggered for the message interaction interface, an animation parameter in real time based on the gesture; and
distributing the animation parameter to a subscriber module to execute a form switching animation represented by the animation parameter through the subscriber module and perform form switching on the message interaction interface.

20. An electronic device comprising:
a processor; and
a memory storing a computer program that, when executed by the processor, causes the processor to:
present a message interaction interface in an initial form, the message interaction interface displaying a plurality of message nodes associated with a target object, and the plurality of message nodes including one or more community nodes and one or more instant messaging (IM) nodes; and
switch, in response to a selection operation for a target community node of the one or more community nodes, the message interaction interface from the initial form to a target form in which at least one screened community node associated with the target object is determined by screening, the target form displaying a node identification of the at least one screened community node and at least one sub-community contained in the target community node, and the at least one screened community node including the target community node.
